(19) United States
(12) Patent Application Publication
(10) Pub. No.: US 2025/0287136 A1
(43) Pub. Date: Sep. 11, 2025

(54) Noise Cancellation Method, Headset, Apparatus, Storage Medium, and Computer Program Product

(71) Applicant: Huawei Technologies Co., Ltd., Shenzhen (CN)

(72) Inventors: Yulong Li, Shenzhen (CN); Jiasheng Li, Shenzhen (CN); Shan Ouyang, Shenzhen (CN); Guopeng Wu, Shenzhen (CN); Peinian Yang, Shenzhen (CN); Fan Fan, Shenzhen (CN)

(21) Appl. No.: 19/219,172

(22) Filed: May 27, 2025

Related U.S. Application Data
(63) Continuation of application No. PCT/CN2023/103264, filed on Jun. 28, 2023.

(30) Foreign Application Priority Data
Nov. 28, 2022 (CN) 202211506453.2

(51) Int. Cl. H04R 1/10; G10K 11/178

(52) U.S. Cl. CPC H04R 1/1083; G10K 11/17815; G10K 2210/1081; G10K 2210/3012; G10K 2210/3026; G10K 2210/3027; G10K 2210/3028; H04R 2460/01

(57) ABSTRACT

A noise cancellation method includes: determining a plurality of groups of target noise cancellation parameters that are in a one-to-one correspondence with a plurality of first speakers of a headset; generating, based on the plurality of groups of target noise cancellation parameters, a plurality of groups of target inverse phase noise that are in a one-to-one correspondence with the plurality of first speakers, where a frequency band of each target inverse phase noise in the plurality of groups of target inverse phase noise covers a sound-making frequency band of the plurality of first speakers; and performing noise cancellation through the plurality of first speakers by using the plurality of groups of target inverse phase noise.

### CROSS-REFERENCE TO RELATED APPLICATIONS

This is a continuation of International Patent Application No. PCT/CN2023/103264 filed on Jun. 28, 2023, which claims priority to Chinese Patent Application No. 202211506453.2 filed on Nov. 28, 2022. The disclosures of the aforementioned applications are hereby incorporated by reference in their entireties.

### TECHNICAL FIELD

The present disclosure relates to the field of audio processing technologies, and in particular, to a noise cancellation method, a headset, an apparatus, a storage medium, and a computer program product.

### BACKGROUND

When a user wears a headset to listen to audio signals such as music or a voice, definition of the audio signals heard by the user is affected if there is environment noise, and the user cannot even hear the audio signals in the headset clearly when the environment noise is severe. Therefore, active noise cancellation of the headset needs to be implemented, to eliminate, as much as possible, the environment noise heard by the headset wearer.

There are many challenges in the active noise cancellation of the headset. The environment noise is variable and irregular. In addition, an extent to which the environment noise leaks into an ear canal is related to a degree of fitting between the headset and the human ear. However, different people have different ear canal sizes and shapes, and when different people wear a same headset, degrees of fitting between the headsets and human ears are different, resulting in different noise leakage degrees. When a same user wears a same headset a plurality of times, degrees of fitting between the headset and the human ear may also be different. Therefore, how to improve effect of active noise cancellation of a headset to avoid impact of environment noise on a headset wearer as much as possible is a current research hotspot.

### SUMMARY

The present disclosure provides a noise cancellation method, a headset, an apparatus, a storage medium, and a computer program product, to improve effect of active noise cancellation of the headset. The technical solutions are as follows.

According to a first aspect, a noise cancellation method is provided, applied to a headset. The headset includes at least one reference microphone, one error microphone, and a plurality of first speakers. The method includes: determining a plurality of groups of target noise cancellation parameters that are in a one-to-one correspondence with the plurality of first speakers; generating, based on the plurality of groups of target noise cancellation parameters, a plurality of groups of target inverse phase noise that are in a one-to-one correspondence with the plurality of first speakers, where a frequency band of each target inverse phase noise in the plurality of groups of target inverse phase noise covers a sound-making frequency band of the plurality of first speakers; and performing noise cancellation through the plurality of first speakers by using the plurality of groups of target inverse phase noise.

Because the plurality of groups of target inverse phase noise are in the one-to-one correspondence with the plurality of first speakers, and the frequency band of each target inverse phase noise in the plurality of groups of target inverse phase noise covers the sound-making frequency band of the plurality of first speakers. In other words, each target inverse phase noise is full-band inverse phase noise. Therefore, regardless of whether the first speaker is a high-band speaker, a low-band speaker, or a full-band speaker, a noise cancellation capability of each first speaker can be fully utilized when the plurality of groups of target inverse phase noise are used to perform noise cancellation. In other words, in a headset architecture including a plurality of noise cancellation channels and a plurality of speakers, in this solution, noise cancellation effect of a headset can be improved by using full-band inverse phase noise of the plurality of noise cancellation channels.

According to the noise cancellation method provided in the present disclosure, the plurality of groups of target noise cancellation parameters can be determined on a per-frame basis. In other words, the plurality of groups of target noise cancellation parameters that are in the one-to-one correspondence with the plurality of first speakers are determined in each frame. Certainly, the target noise cancellation parameters can alternatively be determined in another time unit. For example, the plurality of groups of target noise cancellation parameters that are in the one-to-one correspondence with the plurality of first speakers are determined in every two frames. The following uses a frame as a unit for description.

The headset further includes a plurality of feedforward (FF) filters that are in a one-to-one correspondence with the plurality of first speakers. In this case, the plurality of groups of target noise cancellation parameters include k^{th}-frame filter coefficients of the plurality of FF filters, where k is an integer greater than or equal to 1. In some cases, the headset further includes a plurality of feedback (FB) filters that are in a one-to-one correspondence with the plurality of first speakers. In other words, the plurality of FB filters are in a one-to-one correspondence with the plurality of FF filters. In this case, the plurality of groups of target noise cancellation parameters further include k^{th}-frame filter coefficients of the plurality of FB filters. In addition, when the headset further includes a downlink compensation filter, the plurality of groups of target noise cancellation parameters further include a k^{th}-frame filter coefficient of the downlink compensation filter. In addition, when k is greater than 1, a target noise canceling level may be further determined. Therefore, the following separately describes the four parts.

(1) Determine the k^{th}-Frame Filter Coefficients of the Plurality of FF Filters.

When k is equal to 1, initial filter coefficients of the plurality of FF filters are determined as the k^{th}-frame filter coefficients of the plurality of FF filters, that is, first-frame filter coefficients of the plurality of FF filters are the initial filter coefficients of the corresponding FF filters, or the k^{th}-frame filter coefficients of the plurality of FF filters are determined based on an initial noise canceling level and a mapping relationship between a noise canceling level and an FF filter coefficient. When k is greater than 1, the k^{th}-frame filter coefficients of the plurality of FF filters are determined based on a (k−1)^{th}-frame reference signal collected by the at least one reference microphone, a (k−1)^{th}-frame error signal collected by the error microphone, and a target noise canceling level. In other words, the k^{th}-frame filter coefficients of the plurality of FF filters are determined according to an adaptation method. The determining process is an adaptation process, and may also be referred to as an iteration process.

It should be noted that the initial filter coefficients of the plurality of FF filters may be the same or may be different, and the initial filter coefficients may be 0 or may not be 0. This is not limited in embodiments of the present disclosure. The initial noise canceling level may be a preset level, and the level is a level at which noise cancellation can be normally performed by using a corresponding noise cancellation coefficient without introducing a stability problem. Certainly, the initial noise canceling level may alternatively be a level determined based on a prompt tone like “Noise cancellation on” or “Dingdong” sent by a user terminal when noise cancellation starts. A noise cancellation coefficient corresponding to the level can better adapt to a current human ear and wearing posture, and a convergence state can be reached more quickly by performing adaptive iteration based on the noise cancellation coefficient corresponding to the level. This is also not limited in embodiments of the present disclosure.

An implementation process of determining the k^{th}-frame filter coefficients of the plurality of FF filters based on the (k−1)^{th}-frame reference signal collected by the at least one reference microphone, the (k−1)^{th}-frame error signal collected by the error microphone, and the target noise canceling level includes: determining (k−1)^{th}-frame filter coefficients of a plurality of secondary paths (SPs) based on the target noise canceling level and a mapping relationship between a noise canceling level and a filter coefficient of an SP, where the plurality of SPs are paths from the plurality of first speakers to the error microphone; and determining the k^{th}-frame filter coefficients of the plurality of FF filters based on the (k−1)^{th}-frame reference signal collected by the at least one reference microphone, the (k−1)^{th}-frame error signal collected by the error microphone, and the (k−1)^{th}-frame filter coefficients of the plurality of SPs.

The k^{th}-frame filter coefficients of the plurality of FF filters may be determined in a multi-channel linkage manner. In addition, when the headset includes a plurality of FF filters, the headset may further include a plurality of FB filters that are in a one-to-one correspondence with the plurality of first speakers, or may not include the plurality of FB filters. In different cases, manners of determining the k^{th}-frame filter coefficients of the plurality of FF filters are different. The manners are separately described below.

Because processes of determining the k^{th}-frame filter coefficients of the FF filters based on the (k−1)^{th}-frame reference signal collected by the at least one reference microphone, the (k−1)^{th}-frame error signal collected by the error microphone, and the (k−1)^{th}-frame filter coefficients of the plurality of SPs are the same, one of the processes is used as an example for description below. In other words, one of the plurality of FF filters is used as a target FF filter, and a k^{th}-frame filter coefficient of the target FF filter is determined in the following manner. For a process of determining a k^{th}-frame filter coefficient of another FF filter in the plurality of FF filters, refer to the process of determining the k^{th}-frame filter coefficient of the target FF filter.

In a first case, the headset does not include the plurality of FB filters. If the target FF filter is a first FF filter, the k^{th}-frame filter coefficient of the target FF filter is determined based on a (k−1)^{th}-frame reference signal collected by a target reference microphone, the (k−1)^{th}-frame error signal collected by the error microphone, and a (k−1)^{th}-frame filter coefficient of a target SP, where the target reference microphone is a reference microphone corresponding to the target FF filter, and the target SP is a path from a first speaker corresponding to the target FF filter to the error microphone. If the target FF filter is a non-first FF filter, the k^{th}-frame filter coefficient of the target FF filter is determined based on a (k−1)^{th}-frame reference signal collected by a target reference microphone, the (k−1)^{th}-frame error signal collected by the error microphone, the (k−1)^{th}-frame filter coefficients of the plurality of SPs, and k^{th}-frame frequency response information and (k−1)^{th}-frame frequency response information that are of each FF filter before the target FF filter.

When the target FF filter is the first FF filter, a residual error is determined based on the (k−1)^{th}-frame reference signal collected by the target reference microphone and the (k−1)^{th}-frame error signal collected by the error microphone, and k^{th}-frame frequency response information of the target FF filter is determined based on (k−1)^{th}-frame frequency response information of the target FF filter, the (k−1)^{th}-frame filter coefficient of the target SP, and the residual error. The k^{th}-frame filter coefficient of the target FF filter is determined based on the k^{th}-frame frequency response information of the target FF filter.

One of the plurality of FF filters corresponds to one reference microphone. In other words, the target reference microphone includes one reference microphone. In this case, the residual error is determined based on the (k−1)^{th}-frame reference signal collected by the target reference microphone and the (k−1)^{th}-frame error signal collected by the error microphone.

One of the plurality of FF filters corresponds to at least two reference microphones. In other words, the target reference microphone includes at least two reference microphones. In this case, audio mixing is performed on (k−1)^{th}-frame reference signals collected by the at least two reference microphones included in the target reference microphone, to obtain a (k−1)^{th}-frame mixed reference signal. The residual error is determined based on the (k−1)^{th}-frame mixed reference signal and the (k−1)^{th}-frame error signal collected by the error microphone. In this way, a signal-to-noise ratio of a reference signal can be improved.

When the target FF filter is a non-first FF filter, the residual error is determined based on the (k−1)^{th}-frame reference signal collected by the target reference microphone and the (k−1)^{th}-frame error signal collected by the error microphone, and k^{th}-frame frequency response information of the target FF filter is determined based on (k−1)^{th}-frame frequency response information of the target FF filter, the residual error, the (k−1)^{th}-frame filter coefficients of the plurality of SPs, and the k^{th}-frame frequency response information and the (k−1)^{th}-frame frequency response information that are of each FF filter before the target FF filter. The k^{th}-frame filter coefficient of the target FF filter is determined based on the k^{th}-frame frequency response information of the target FF filter.

When the k^{th}-frame frequency response information of the target FF filter is determined, the k^{th}-frame frequency response information of the target FF filter may be determined based on the (k−1)^{th}-frame frequency response information of the target FF filter, the residual error, a (k−1)^{th}-frame filter coefficient of a target SP, the k^{th}-frame frequency response information and the (k−1)^{th}-frame frequency response information that are of each FF filter before the target FF filter, and a (k−1)^{th}-frame filter coefficient of an SP corresponding to each FF filter before the target FF filter.

An implementation process of determining the k^{th}-frame filter coefficient of the target FF filter based on the k^{th}-frame frequency response information of the target FF filter includes: establishing a loss function between a filter coefficient variable of the target FF filter and the k^{th}-frame frequency response information of the target FF filter. A value of the filter coefficient variable is determined based on the loss function according to a gradient descent method, and the k^{th}-frame filter coefficient of the target FF filter is determined based on the value of the filter coefficient variable. In other words, the loss function between the filter coefficient variable of the target FF filter and the k^{th}-frame frequency response information of the target FF filter is established. An optimal value of the variable is determined according to the gradient descent method, so that the k^{th}-frame filter coefficient of the target FF filter is determined based on the optimal value of the variable.

A filter coefficient of the target FF filter in each frame is determined according to the gradient descent method. One value of the loss function is determined when the filter coefficient of the target FF filter in each frame is determined. When the value of the loss function reaches a minimum threshold, it is determined that a filter coefficient of the target FF filter reaches a convergence stability condition. For example, for the k^{th}-frame filter coefficient of the target FF filter, when the value of the loss function between the filter coefficient variable and the k^{th}-frame frequency response information of the target FF filter reaches the minimum threshold, it is determined that the k^{th}-frame filter coefficient of the target FF filter reaches the convergence stability condition. When the value of the loss function does not reach the minimum threshold, it is determined that the k^{th}-frame filter coefficient of the target FF filter does not reach the convergence stability condition. The minimum threshold is preset, and may be adjusted based on different requirements in different cases.

Optionally, a filter coefficient of each FF filter includes at least one biquad filter coefficient and one gain. Variables corresponding to the biquad filter coefficient include a filter type, a cut-off frequency, and a quality factor. Certainly, in actual application, the filter coefficient of each FF filter may further include more or fewer other parameters. This is not limited in the present disclosure.

In some cases, there is a problem of background noise, namely, noise floor, in a quiet environment. For example, for a semi-open headset, the headset is more likely to have a background noise problem in a quiet environment than an in-ear headset. In addition, strong noise cancellation is not required in the quiet environment, and some people may feel uncomfortable when strong noise cancellation is performed in the quiet environment. In addition, larger noise cancellation strength indicates a stronger negative pressure feeling of a person. Therefore, when the value of the filter coefficient variable is determined according to the gradient descent method, a target noise cancellation amplitude may be dynamically adjusted based on an environmental volume, so that the k^{th}-frame filter coefficient of the target FF filter is determined based on the target noise cancellation amplitude, to improve subjective experience effect of adaptive noise cancellation. In other words, the target noise cancellation amplitude is determined based on a (k−1)^{th}-frame environmental volume and environmental volumes in t frames before the (k−1)^{th} frame, where t is greater than or equal to 1 and less than k−1. The value of the filter coefficient variable is determined based on the target noise cancellation amplitude and the loss function according to the gradient descent method, and the k^{th}-frame filter coefficient of the target FF filter is determined based on the value of the filter coefficient variable.

In a second case, the headset further includes the plurality of FB filters. If the target FF filter is a first FF filter, the k^{th}-frame filter coefficient of the target FF filter is determined based on a (k−1)^{th}-frame reference signal collected by a target reference microphone, the (k−1)^{th}-frame error signal collected by the error microphone, the (k−1)^{th}-frame filter coefficients of the plurality of SPs, and the (k−1)^{th}-frame filter coefficients of the plurality of FB filters. If the target FF filter is a non-first FF filter, the k^{th}-frame filter coefficient of the target FF filter is determined based on a (k−1)^{th}-frame reference signal collected by a target reference microphone, the (k−1)^{th}-frame error signal collected by the error microphone, the (k−1)^{th}-frame filter coefficients of the plurality of SPs, the (k−1)^{th}-frame filter coefficients of the plurality of FB filters, and k^{th}-frame frequency response information and (k−1)^{th}-frame frequency response information that are of each FF filter before the target FF filter.

When the target FF filter is the first FF filter, the residual error may be determined based on the (k−1)^{th}-frame reference signal collected by the target reference microphone and the (k−1)^{th}-frame error signal collected by the error microphone, and k^{th}-frame frequency response information of the target FF filter is determined based on (k−1)^{th}-frame frequency response information of the target FF filter, the residual error, the (k−1)^{th}-frame filter coefficients of the plurality of FB filters, and the (k−1)^{th}-frame filter coefficients of the plurality of SPs. The k^{th}-frame filter coefficient of the target FF filter is determined based on the k^{th}-frame frequency response information of the target FF filter.

When the target FF filter is the non-first FF filter, the residual error may be determined based on the (k−1)^{th}-frame reference signal collected by the target reference microphone and the (k−1)^{th}-frame error signal collected by the error microphone, and k^{th}-frame frequency response information of the target FF filter is determined based on (k−1)^{th}-frame frequency response information of the target FF filter, the residual error, the (k−1)^{th}-frame filter coefficients of the plurality of SPs, the (k−1)^{th}-frame filter coefficients of the plurality of FB filters, and k^{th}-frame frequency response information and (k−1)^{th}-frame frequency response information that are of each FF filter before the target FF filter. The k^{th}-frame filter coefficient of the target FF filter is determined based on the k^{th}-frame frequency response information of the target FF filter.

In the foregoing processes of determining the k^{th}-frame frequency response information of the target FF filter, regardless of whether the headset includes a target FB filter, the k^{th}-frame frequency response information of the target FF filter is determined based on the (k−1)^{th}-frame filter coefficient of the target SP, and the (k−1)^{th}-frame filter coefficient of the target SP is determined based on the target noise canceling level by querying the mapping relationship between the noise canceling level and the filter coefficient of the SP. To be specific, the (k−1)^{th}-frame filter coefficient of the target SP is an estimated value, and the k^{th}-frame frequency response information of the target FF filter is determined based on the estimated value, so that dependence on a real value of the target SP can be eliminated, and adaptation of filter coefficients of FF filters can also be implemented when there is no downlink signal.

(2) Determine the k^{th}-Frame Filter Coefficients of the Plurality of FB Filters.

When k is equal to 1, initial filter coefficients of the plurality of FB filters are determined as the k^{th}-frame filter coefficients of the plurality of FB filters, that is, first-frame filter coefficients of the plurality of FB filters are the initial filter coefficients of the corresponding FB filters, or the k^{th}-frame filter coefficients of the plurality of FB filters are determined based on an initial noise canceling level and a mapping relationship between a noise canceling level and an FB filter coefficient. When k is greater than 1, the k^{th}-frame filter coefficients of the plurality of FB filters may be determined based on the target noise canceling level.

It should be noted that the initial filter coefficients of the plurality of FB filters may be the same or may be different, and the initial filter coefficients may be 0 or may not be 0. This is not limited in embodiments of the present disclosure.

Because processes of determining k^{th}-frame filter coefficients of the FB filters based on the target noise canceling level are the same, one of the processes is used as an example for description below. In other words, one of the plurality of FB filters is used as a target FB filter, and a k^{th}-frame filter coefficient of the target FB filter is determined in the following two manners. For a process of determining a k^{th}-frame filter coefficient of another FB filter in the plurality of FB filters, refer to the process of determining the k^{th}-frame filter coefficient of the target FB filter. In other words, when k is greater than 1, the k^{th}-frame filter coefficient of the target FB filter may be determined in the following two manners.

In a first manner, the k^{th}-frame filter coefficient of the target FB filter is determined based on the target noise canceling level and the mapping relationship between the noise canceling level and the FB filter coefficient.

Because the mapping relationship between the noise canceling level and the FB filter coefficient is stored in advance, determining the k^{th}-frame filter coefficient of the target FB filter in the first manner is stable, an operation is simple, and efficiency is high.

In a second manner, if the target FB filter is a first-type FB filter, the k^{th}-frame filter coefficient of the target FB filter is determined based on the target noise canceling level and the mapping relationship between the noise canceling level and the FB filter coefficient. If the target FB filter is a second-type FB filter, the k^{th}-frame filter coefficient of the target FB filter is determined based on a (k−1)^{th}-frame error signal collected by the error microphone, a (k−1)^{th}-frame filter coefficient of the target FB filter, and the target noise canceling level.

A first-frame filter coefficient of the target FB filter may be determined based on the initial noise canceling level by querying the mapping relationship between the noise canceling level and the FB filter coefficient. Therefore, when k is greater than or equal to 1, it is equivalent to that the k^{th}-frame filter coefficient of the target FB filter may be determined in three manners. To be specific, (1) the k^{th}-frame filter coefficient of the target FB filter is determined by querying the mapping relationship between the noise canceling level and the FB filter coefficient. (2) If the target FB filter is the first-type FB filter, the k^{th}-frame filter coefficient of the target FB filter is determined by querying the mapping relationship between the noise canceling level and the FB filter coefficient. If the target FB filter is the second-type FB filter, the k^{th}-frame filter coefficient of the target FB filter is determined based on the (k−1)^{th}-frame error signal collected by the error microphone, the (k−1)^{th}-frame filter coefficient of the target FB filter, and the target noise canceling level. (3) If the target FB filter is the first-type FB filter, or the target FB filter is the second-type FB filter and k is equal to 1, the k^{th}-frame filter coefficient of the target FB filter is determined by querying the mapping relationship between the noise canceling level and the FB filter coefficient. If the target FB filter is the second-type FB filter and k is greater than 1, the k^{th}-frame filter coefficient of the target FB filter is determined based on the (k−1)^{th}-frame error signal collected by the error microphone, the (k−1)^{th}-frame filter coefficient of the target FB filter, and the target noise canceling level.

An implementation process of determining the k^{th}-frame filter coefficient of the target FB filter based on the (k−1)^{th}-frame error signal collected by the error microphone, the (k−1)^{th}-frame filter coefficient of the target FB filter, and the target noise canceling level includes: determining a (k−1)^{th}-frame filter coefficient of a target SP based on the target noise canceling level and a mapping relationship between a noise canceling level and a filter coefficient of an SP, where the target SP is a path from a first speaker corresponding to the target FB filter to the error microphone; and determining the k^{th}-frame filter coefficient of the target FB filter based on the (k−1)^{th}-frame error signal collected by the error microphone, the (k−1)^{th}-frame filter coefficient of the target FB filter, and the (k−1)^{th}-frame filter coefficient of the target SP.

A sound-making frequency band of a first speaker corresponding to the first-type FB filter is higher than a sound-making frequency band of a first speaker corresponding to the second-type FB filter. In other words, the first speaker corresponding to the first-type FB filter is a high-band speaker, and the first speaker corresponding to the second-type FB filter is a low-band speaker. Certainly, the first-type FB filter and the second-type FB filter may not be distinguished based on a sound-making frequency band, but may be distinguished in another manner. This is also not limited in the present disclosure.

In the foregoing second manner and third manner, a manner of querying the mapping relationship between the noise canceling level and the FB filter coefficient is combined with an adaptive manner, so that noise cancellation effect can be improved, complexity is not high, and stability is controllable.

It should be noted that the k^{th}-frame filter coefficient of the target FB filter may be determined in the foregoing three manners, and the k^{th}-frame filter coefficient of the target FB filter may alternatively be determined in another manner. For example, regardless of whether the target FB filter is the first-type FB filter or the second-type FB filter, the k^{th}-frame filter coefficient of the target FB filter is determined based on the (k−1)^{th}-frame error signal collected by the error microphone, the (k−1)^{th}-frame filter coefficient of the target FB filter, and the target noise canceling level. This is not limited in embodiments of the present disclosure.

(3) Determine the k^{th}-Frame Filter Coefficient of the Downlink Compensation Filter.

When k is equal to 1, an initial filter coefficient of the downlink compensation filter is determined as the k^{th}-frame filter coefficient of the downlink compensation filter, or the k^{th}-frame filter coefficient of the downlink compensation filter is determined based on an initial noise canceling level and a mapping relationship between a noise canceling level and a downlink compensation filter coefficient. When k is greater than 1, the k^{th}-frame filter coefficient of the downlink compensation filter is determined based on the target noise canceling level and the mapping relationship between the noise canceling level and the downlink compensation filter coefficient.

The mapping relationship between the noise canceling level and the downlink compensation filter coefficient includes a plurality of noise canceling levels, a mapping relationship exists between each noise canceling level and a filter coefficient of the downlink compensation filter, and mapping relationships between different noise canceling levels and filter coefficients of the downlink compensation filter may be different. Therefore, after the target noise canceling level is determined, a corresponding downlink compensation filter coefficient can be obtained from the mapping relationship between the noise canceling level and the downlink compensation filter coefficient based on the target noise canceling level, and the obtained downlink compensation filter coefficient is used as the k^{th}-frame filter coefficient of the downlink compensation filter.

### (4) Determine the Target Noise Canceling Level.

A (k−1)^{th}-frame noise canceling level is determined, and noise canceling levels in m frames before a (k−1)^{th} frame are obtained, where m is greater than or equal to 1 and less than k−1. The target noise canceling level is determined based on the (k−1)^{th}-frame noise canceling level and the noise canceling levels in the m frames.

In the (k−1)^{th} frame, a valid downlink signal may exist, or no valid downlink signal may exist, and an environment may be quiet, or an environment may not be quiet, or certainly, an abnormal signal may exist. In different cases, manners of determining the (k−1)^{th}-frame noise canceling level are different, and are separately described below.

In a first case, in the (k−1)^{th} frame, no valid downlink signal exists and the environment is not quiet. In this case, the (k−1)^{th}-frame noise canceling level is determined based on reference filter coefficients of the plurality of FF filters and a mapping relationship between a noise canceling level and frequency response information of an FF filter. When k is equal to 2, the reference filter coefficients are initial filter coefficients of the corresponding FF filters; or when k is greater than 2, the reference filter coefficients are filter coefficients that are of the corresponding FF filters and that meet a convergence stability condition last time before a k^{th} frame, or are (k−1)^{th}-frame filter coefficients of the corresponding FF filters.

Reference frequency response information of the plurality of FF filters is determined based on the reference filter coefficients of the plurality of FF filters. Noise canceling levels matching the reference frequency response information of the plurality of FF filters are determined based on the mapping relationship between the noise canceling level and the frequency response information of the FF filter, to obtain a plurality of reference noise canceling levels. The (k−1)^{th}-frame noise canceling level is determined based on the plurality of reference noise canceling levels.

There are a plurality of manners of determining the (k−1)^{th}-frame noise canceling level based on the plurality of reference noise canceling levels. For example, the (k−1)^{th}-frame noise canceling level is determined based on an average value of the plurality of reference noise canceling levels. Alternatively, the (k−1)^{th}-frame noise canceling level is determined based on a reference noise canceling level with a largest quantity in the plurality of reference noise canceling levels.

When the (k−1)^{th}-frame noise canceling level is determined based on the average value of the plurality of reference noise canceling levels, the average value of the plurality of reference noise canceling levels may be directly determined as the (k−1)^{th}-frame noise canceling level, or the average value of the plurality of reference noise canceling levels may be adjusted to obtain the (k−1)^{th}-frame noise canceling level. Similarly, when the (k−1)^{th}-frame noise canceling level is determined based on the reference noise canceling level with the largest quantity in the plurality of reference noise canceling levels, the reference noise canceling level with the largest quantity in the plurality of reference noise canceling levels may be directly determined as the (k−1)^{th}-frame noise canceling level, or the reference noise canceling level with the largest quantity in the plurality of reference noise canceling levels may be adjusted to obtain the (k−1)^{th}-frame noise canceling level.

In a second case, the valid downlink signal exists in the (k−1)^{th} frame. In this case, the (k−1)^{th}-frame noise canceling level is determined based on the (k−1)^{th}-frame valid downlink signal, a (k−1)^{th}-frame reference signal collected by the at least one reference microphone, and a (k−1)^{th}-frame error signal collected by the error microphone.

In view of the foregoing descriptions, when the headset is in a downlink enabled state and is not in a downlink intermittent period, it is determined that the valid downlink signal exists in the (k−1)^{th} frame. In this case, a valid downlink signal may be extracted from the (k−1)^{th}-frame error signal collected by the error microphone based on the (k−1)^{th}-frame valid downlink signal, the (k−1)^{th}-frame reference signal collected by the at least one reference microphone, and the (k−1)^{th}-frame error signal collected by the error microphone, to determine the (k−1)^{th}-frame noise canceling level based on the extracted valid downlink signal.

In a third case, in the (k−1)^{th} frame, no valid downlink signal exists and the environment is quiet, or the abnormal noise signal exists in the (k−1)^{th} frame. In this case, a (k−3)^{th}-frame noise canceling level is determined as the (k−1)^{th}-frame noise canceling level. In other words, the noise canceling level remains unchanged.

In the (k−1)^{th} frame, when no valid downlink signal exists and the environment is quiet, noise basically does not change. In this case, the noise canceling level may remain unchanged. When the abnormal noise signal exists in the (k−1)^{th} frame, the noise canceling level remains unchanged, to perform robustness control, and avoid divergence of the noise canceling level.

After the (k−1)^{th}-frame noise canceling level is determined in the foregoing three cases, the (k−1)^{th}-frame noise canceling level and the noise canceling levels in the m frames before the (k−1)^{th} frame may be integrated, to determine the target noise canceling level.

The noise canceling levels in the m frames may be noise canceling levels in any m frames before the (k−1)^{th} frame, or may be noise canceling levels in m frames that are before the (k−1)^{th} frame and that are closest to the (k−1)^{th} frame. In addition, there are a plurality of implementations of determining the target noise canceling level based on the (k−1)^{th}-frame noise canceling level and the noise canceling levels in the m frames before the (k−1)^{th} frame. For example, noise cancellation effect is evaluated according to a related algorithm, to determine a noise cancellation probability corresponding to the (k−1)^{th}-frame noise canceling level and noise cancellation probabilities corresponding to the noise canceling levels in the m frames, and determine a noise canceling level with a largest noise cancellation probability as the target noise canceling level. Alternatively, an arithmetic average value or a weighted average value of the (k−1)^{th}-frame noise canceling level and the noise canceling levels in the m frames is determined, to obtain the target noise canceling level. Alternatively, a noise canceling level that appears most frequently in the (k−1)^{th}-frame noise canceling level and the noise canceling levels in the m frames is determined as the target noise canceling level, or the like.

In view of the foregoing descriptions, the plurality of groups of target noise cancellation parameters may be referred to as noise cancellation parameters of the plurality of noise cancellation channels. In this way, the generated plurality of groups of target inverse phase noise may also be referred to as inverse phase noise of the plurality of noise cancellation channels. Because processes of generating inverse phase noise of the noise cancellation channels are the same, the following uses one of the noise cancellation channels as an example for description.

One of the plurality of noise cancellation channels is used as a target noise cancellation channel, the target noise cancellation channel includes a target FF filter and a target first speaker, and a reference microphone corresponding to the target FF filter is referred to as a target reference microphone. In this case, the target inverse phase noise includes feedforward inverse phase noise. In other words, a k^{th}-frame reference signal collected by the target reference microphone is processed based on a k^{th}-frame filter coefficient of the target FF filter, to obtain the feedforward inverse phase noise.

In view of the foregoing descriptions, the target reference microphone may include one reference microphone, or may include at least two reference microphones. When the target reference microphone includes one reference microphone, the k^{th}-frame reference signal collected by the target reference microphone may be processed directly based on the k^{th}-frame filter coefficient of the target FF filter, to obtain the feedforward inverse phase noise. When the target reference microphone includes at least two reference microphones, audio mixing is performed on k^{th}-frame reference signals collected by the at least two reference microphones, to obtain a k^{th}-frame mixed reference signal, and then the k^{th}-frame mixed reference signal is processed based on the k^{th}-frame filter coefficient of the target FF filter, to obtain the feedforward inverse phase noise.

When the headset further includes an FB filter, the target noise cancellation channel further includes a target FB filter. In this case, the target inverse phase noise further includes feedback inverse phase noise. In other words, downlink compensation is performed, based on the k^{th}-frame filter coefficient of the downlink compensation filter, on a k^{th}-frame downlink signal sent by the user terminal. Then, after negation is performed on a k^{th}-frame downlink signal obtained through downlink compensation, audio mixing is performed on a negated k^{th}-frame downlink signal and a k^{th}-frame error signal collected by the error microphone, to obtain a k^{th}-frame noise signal collected by the error microphone. The k^{th}-frame noise signal collected by the error microphone is processed based on the k^{th}-frame filter coefficient of the target FB filter, to obtain the feedback inverse phase noise.

Downlink compensation can be used to remove all downlink signals in error signals collected by the error microphone, so that noise cancellation is performed only on a residual noise signal through the FB filter, to avoid a sound quality damage to the downlink signals. In addition, downlink compensation is performed on the k^{th}-frame downlink signal sent by the user terminal, so that downlink signals of all speakers at the error microphone can be removed, to avoid a sound quality damage to full-band downlink signals.

In view of the foregoing descriptions, when the plurality of groups of target noise cancellation parameters are determined on a per-frame basis, because one frame may include one sample point, or may include a plurality of sample points, when the target inverse phase noise is generated, a group of target inverse phase noise may be generated at each sample point, or a group of target inverse phase noise may be generated in one frame.

When the plurality of groups of target noise cancellation parameters are determined, frequency division is not performed on the downlink signals, that is, the plurality of groups of target noise cancellation parameters are determined based on full-band downlink signals. In this way, after the plurality of groups of target inverse phase noise that are in the one-to-one correspondence with the plurality of first speakers are generated based on the plurality of groups of target noise cancellation parameters, a frequency band of each target inverse phase noise in the plurality of groups of target inverse phase noise covers a sound-making frequency band of the plurality of first speakers, that is, the frequency band of each target inverse phase noise is a full frequency band.

After the plurality of groups of target inverse phase noise are generated, the plurality of groups of target inverse phase noise are respectively mixed with k^{th}-frame downlink signals to be played through the plurality of first speakers, and then mixed signals are played through the corresponding first speakers, to achieve noise cancellation.

Some of the plurality of first speakers may be high-band speakers, and the other may be low-band speakers. Alternatively, some of the plurality of first speakers are full-band speakers, and the other are non-full-band speakers. In other words, the sound-making frequency bands of the plurality of first speakers may be different. Alternatively, the plurality of first speakers are all full-band speakers. Alternatively, the plurality of first speakers are all non-full-band speakers. When the plurality of first speakers are all the full-band speakers, the k^{th}-frame downlink signals to be played through the plurality of first speakers are all the k^{th}-frame downlink signal sent by the user terminal. When not all of the plurality of first speakers are the full-band speakers, frequency division needs to be performed, based on a sound-making frequency band of each first speaker, on the k^{th}-frame downlink signal sent by the user terminal, to obtain a k^{th}-frame downlink signal to be played through each first speaker.

Two first speakers in the plurality of first speakers may include two first speakers formed by one dual diaphragm (or referred to as dual-dynamic) loudspeaker. Alternatively, the plurality of first speakers include a plurality of split speakers/loudspeakers.

Optionally, the headset may further include at least one second speaker, and the at least one second speaker does not participate in noise cancellation. In this case, the second speaker may participate in downlink compensation (that is, downlink compensation is performed on a downlink signal sent by the user terminal, where the downlink signal is a full-band audio signal, including an audio signal of a sound-making frequency band of the second speaker). In this case, the first speaker may be a low- and medium-band speaker, or may be a full-band speaker, and the second speaker may be a high-band speaker, or may be a medium-band speaker or a low-band speaker. Optionally, the second speaker may not participate in downlink compensation. In this case, the first speaker may be the low- and medium-band speaker, or may be the full-band speaker, and the second speaker is the high-band speaker.

The foregoing process of determining the plurality of groups of target noise cancellation parameters according to the adaptation method requires specific time, and when one frame includes a plurality of sample points and duration of the one frame is long, duration of determining the plurality of groups of target noise cancellation parameters is less than the duration of the one frame. Therefore, calculation may be performed in a part of a time period of the k^{th} frame based on related data of the (k−1)^{th} frame, to obtain a plurality of groups of target noise cancellation parameters in the k^{th} frame, and perform active noise cancellation in the other part of the time period of the k^{th} frame based on the plurality of groups of target noise cancellation parameters in the k^{th} frame. However, when the one frame includes one sample point, or the one frame includes a plurality of sample points and the duration of the one frame is short, the duration of determining the plurality of groups of target noise cancellation parameters may be equal to the duration of the one frame. In this case, calculation may need to be performed in the entire time period of the k^{th} frame based on the related data of the (k−1)^{th} frame, to obtain the plurality of groups of target noise cancellation parameters. In this case, the plurality of groups of target noise cancellation parameters may be determined as a plurality of groups of target noise cancellation parameters in the (k+1)^{th} frame, and then active noise cancellation is performed in a time period of the (k+1)^{th} frame based on the plurality of groups of target noise cancellation parameters in the (k+1)^{th} frame. The foregoing content is described by using the former case as an example.

According to a second aspect, a headset is provided. The headset includes at least one reference microphone, one error microphone, a plurality of first speakers, and one noise cancellation processor. The noise cancellation processor is configured to implement the steps of the method according to the first aspect.

Optionally, the plurality of first speakers include two first speakers formed by one dual diaphragm loudspeaker; or the plurality of first speakers include a plurality of speakers with a separate loudspeaker.

Optionally, the headset further includes at least one second speaker, and the at least one second speaker does not participate in noise cancellation.

According to a third aspect, a noise cancellation apparatus is provided. The noise cancellation apparatus has a function of implementing a behavior of the noise cancellation method in the first aspect. The noise cancellation apparatus includes one or more modules, and the one or more modules are configured to implement the noise cancellation method provided in the first aspect.

According to a fourth aspect, a computer-readable storage medium is provided. The computer-readable storage medium stores instructions. When the instructions are run on a computer, the computer is enabled to perform the noise cancellation method described in the first aspect.

According to a fifth aspect, a computer program product that includes instructions is provided. When the instructions are run on a computer, the computer is enabled to perform the noise cancellation method described in the first aspect.

Technical effect obtained in the second aspect to the fifth aspect is similar to technical effect obtained by the corresponding technical means in the first aspect.

### BRIEF DESCRIPTION OF DRAWINGS

FIG. 1 is a diagram of a system architecture related to a noise cancellation method according to an embodiment of the present disclosure;

FIG. 2 is a flowchart of a noise cancellation method according to an embodiment of the present disclosure;

FIG. 3 is a flowchart of determining a target noise cancellation amplitude according to an embodiment of the present disclosure;

FIG. 4 is a diagram of frequency response curves of an FF filter at 16 noise canceling levels according to an embodiment of the present disclosure;

FIG. 5 is a flowchart of determining a (k−1)^{th}-frame noise canceling level according to an embodiment of the present disclosure;

FIG. 6 is a flowchart of determining a plurality of groups of target noise cancellation parameters according to an embodiment of the present disclosure;

FIG. 7 is a diagram of a structure of a headset according to an embodiment of the present disclosure;

FIG. 8 is a diagram of a structure of another headset according to an embodiment of the present disclosure;

FIG. 9 is a diagram of a structure of another headset according to an embodiment of the present disclosure;

FIG. 10 is a diagram of a structure of another headset according to an embodiment of the present disclosure;

FIG. 11 is a diagram of a structure of another headset according to an embodiment of the present disclosure;

FIG. 12 is a diagram of a structure of a noise cancellation apparatus according to an embodiment of the present disclosure; and

FIG. 13 is a diagram of a structure of another headset according to an embodiment of the present disclosure.

### DESCRIPTION OF EMBODIMENTS

To make the objectives, technical solutions, and advantages of the present disclosure clearer, the following further describes the implementations of the present disclosure in detail with reference to the accompanying drawings.

Active noise cancellation headsets are popular in recent years. Noise cancellation headsets are generally in-ear or head-mounted. The reason is that in the two forms, the headset and an ear canal are well sealed, and acoustic leakage is stable when different people wear the headset. This can implement active noise cancellation technically, and has better effect. Therefore, a noise cancellation mode with a fixed coefficient is generally used. However, the two types of headsets also have some disadvantages. For example, sealing between the headset and the ear canal is too good, which affects subjective comfort of people, typically characterized by a foreign body sensation and a sense of closure under conditions such as walking. It is difficult to wear for a long time.

Semi-open headsets are widely accepted by users due to their good comfort. However, in a semi-open form, environment noise is more likely to be felt by people because the headset and the human ear are not well sealed. It is more challenging to implement active noise cancellation in the semi-open headset. The reason is that when different people wear the headset, even when a same person wears the headset different times, wearing postures are greatly different. Technically, response functions and acoustic leakage degrees between the headset and an ear canal are greatly different. Therefore, how to implement adaptive noise cancellation to cope with a problem of differentiation of ear canal responses, and implement optimal matching between a headset and an ear canal is an urgent requirement in the semi-open form. In addition, even in an in-ear form or a head-mounted form, ear canal responses are not absolutely consistent, and there is still a large or small difference. Currently, the industry is also exploring feasibility of adaptive noise cancellation of headsets.

As mentioned above, the headsets have a plurality of forms, such as an in-ear form, a head-mounted form, a semi-open form, and an open form. Audio performance, especially performance in a low frequency, of a speaker (namely, a loudspeaker) in an entire headset is closely related to a specific form of the headset. In a sealed form like the in-ear form or the head-mounted form, audio performance in high, medium, and low frequencies is generally ensured. In the semi-open form or the open form, due to severe acoustic leakage, a low-band response drops greatly. This affects performance of low-band sound quality, and seriously affects active noise cancellation effect (which is insufficient to generate inverse phase noise with sufficient energy).

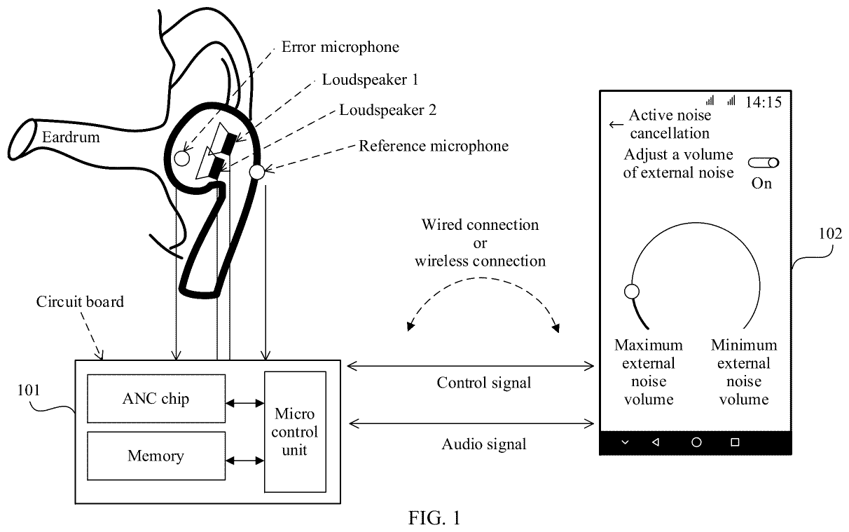

In view of the foregoing problems, embodiments of the present disclosure provide a noise cancellation method, to implement adaptive active noise cancellation (ANC) of a headset. Refer to FIG. 1. FIG. 1 is a diagram of a system architecture related to a noise cancellation method according to an embodiment of the present disclosure. The system may be referred to as a headset noise cancellation system. The system includes a headset 101 and a user terminal 102. The headset 101 and the user terminal 102 are connected in a wired or wireless manner to perform communication. For example, the headset 101 communicates with the user terminal 102 through Bluetooth or through another wireless network.

An audio signal and a control signal can be transmitted between the headset 101 and the user terminal 102. For example, the user terminal 102 sends an audio signal like music or a voice to the headset 101 for playing. For another example, the user terminal 102 sends a control signal to the headset 101, to control whether an active noise cancellation function of the headset 101 is enabled, or the like.

The user terminal 102 may be an electronic device like a mobile phone or a computer (for example, a notebook computer, a desktop computer, a handheld tablet computer, or a vehicle-mounted tablet computer). The user terminal 102 may alternatively be another electronic device, for example, a smart speaker or a vehicle-mounted speaker. A type, a structure, and the like of the user terminal 102 are not limited in embodiments of the present disclosure.

Optionally, the headset 101 provided in embodiments of the present disclosure may be wired or wireless. In addition, from a perspective of a wearing manner, the headset 101 provided in embodiments of the present disclosure may be of a neck-mounted type, an ear-mounted/ear-clip type, a true wireless stereo (TWS) type, or the like. From a perspective of an appearance, the headset 101 provided in embodiments of the present disclosure may be of an in-ear type, a semi-open type, an open type, a head-mounted type, or the like. A communication manner, the wearing manner, and the appearance of the headset are not limited in embodiments of the present disclosure. The following describes, with reference to the wearing manner of the headset in a human ear, a hardware structure of the headset provided in embodiments of the present disclosure.

As shown in FIG. 1, the headset 101 includes a plurality of speakers (namely, loudspeakers), a plurality of microphones, a micro control unit (MCU), an ANC chip, and a memory. The plurality of speakers include a plurality of first speakers, for example, a loudspeaker 1 and a loudspeaker 2. The plurality of first speakers need to participate in noise cancellation. For example, the first speakers are low- and medium-band speakers, and the low- and medium-band speakers need to participate in noise cancellation. Optionally, the plurality of speakers further include at least one second speaker, and the at least one second speaker does not participate in noise cancellation. For example, the second speaker is a high-band speaker, and the high-band speaker does not need to participate in noise cancellation. Certainly, for any speaker, regardless of whether the speaker is a high-band speaker or a low- and medium-band speaker, the speaker may participate in noise cancellation or may not participate in noise cancellation. In other words, in embodiments of the present disclosure, a sound-making frequency band of the first speakers participating in noise cancellation is not limited, and a sound-making frequency band of the second speaker not participating in noise cancellation is not limited. The plurality of microphones include at least one reference microphone and one error microphone. FIG. 1 is described by using one reference microphone as an example.

A speaker is configured to play a downlink signal (for example, an audio signal like music or a voice). Each speaker is driven by using an independent digital to analog converter (DAC) and a power amplifier (PA). In other words, one speaker corresponds to one DAC and one PA, and different speakers correspond to different DACs and PAs. In a noise cancellation process, the first speakers are further configured to play inverse phase noise, where the inverse phase noise is used to reduce a noise signal in an ear canal of a user, to achieve active noise cancellation effect.

The reference microphone is deployed outside the headset. After the headset is worn to a human ear, the reference microphone is located outside the human ear. The reference microphone is configured to collect a noise signal of an external environment. In embodiments of the present disclosure, the noise signal collected by the reference microphone is referred to as a reference signal.

The error microphone is deployed inside the headset. After the headset is worn to the human ear, the error microphone is located inside the human ear. The error microphone is configured to collect a noise signal in the ear canal. In embodiments of the present disclosure, the noise signal collected by the error microphone is referred to as an error signal.

The micro control unit is configured to process the reference signal collected by the reference microphone, the error signal collected by the error microphone, a downlink signal, and the like, to determine a group of target noise cancellation parameters corresponding to each of the plurality of first speakers, and write the group of target noise cancellation parameters corresponding to each first speaker into the ANC chip.

The ANC chip is configured to process, based on the group of target noise cancellation parameters corresponding to each first speaker, the reference signal collected by the reference microphone and the error signal collected by the error microphone, to generate inverse phase noise, perform audio mixing on the generated inverse phase noise and a downlink signal to be played through the first speaker, and output a mixed signal to the corresponding first speaker, so as to reduce a noise signal in the ear canal.

The memory is configured to store an initial parameter, a mapping relationship, and the like that are used when the target noise cancellation parameters corresponding to each first speaker are determined.

It should be noted that the micro control unit, the ANC chip, and the memory may be integrated on a same circuit board, or may be deployed on different circuit boards. This is not limited in embodiments of the present disclosure. In addition, the micro control unit and the ANC chip are merely distinguished in terms of logical function descriptions. In an actual physical form, the micro control unit and the ANC chip may be integrated into one chip, or may be separately deployed on a plurality of chips. For example, the micro control unit and the ANC chip are deployed on two chips.

Optionally, the headset 101 may further include another element, for example, an optical proximity sensor configured to detect whether the headset 101 is in the ear. If the headset 101 is a wireless headset, the headset 101 may further include a wireless communication module, and the wireless communication module may be a wireless local area network module or a Bluetooth module. The wireless communication module is used by the headset 101 to communicate with another device.

It may be understood that the schematic structure in embodiments of the present disclosure does not constitute a limitation on the headset. In some other embodiments, the headset 101 may include more or fewer components than those shown in the figure, or some components may be combined, or some components may be split, or there may be a different component arrangement. The components shown in the figure may be implemented by using hardware, software, or a combination of software and hardware.

The system architecture and a service scenario described in embodiments of the present disclosure are intended to describe the technical solutions in embodiments of the present disclosure more clearly, and do not constitute a limitation on the technical solutions provided in embodiments of the present disclosure. A person of ordinary skill in the art may know that: With the evolution of the system architecture and the emergence of new service scenarios, the technical solutions provided in embodiments of the present disclosure are also applicable to similar technical problems.

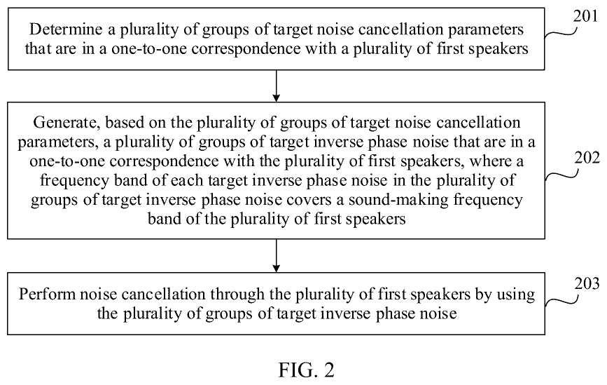

FIG. 2 is a flowchart of a noise cancellation method according to an embodiment of the present disclosure. The method is applied to a headset, and the headset includes at least one reference microphone, one error microphone, and a plurality of first speakers. Refer to FIG. 2. The method includes the following steps.

Step 201: Determine a plurality of groups of target noise cancellation parameters that are in a one-to-one correspondence with the plurality of first speakers.

According to the noise cancellation method provided in this embodiment of the present disclosure, the plurality of groups of target noise cancellation parameters can be determined on a per-frame basis. In other words, the plurality of groups of target noise cancellation parameters that are in the one-to-one correspondence with the plurality of first speakers are determined in each frame. Certainly, the target noise cancellation parameters can alternatively be determined in another time unit. For example, the plurality of groups of target noise cancellation parameters that are in the one-to-one correspondence with the plurality of first speakers are determined in every two frames. The following uses a frame as a unit for description.

In some embodiments, the headset further includes a plurality of FF filters that are in a one-to-one correspondence with the plurality of first speakers. In this case, the plurality of groups of target noise cancellation parameters include k^{th}-frame filter coefficients of the plurality of FF filters, where k is an integer greater than or equal to 1. In some cases, the headset further includes the plurality of FB filters that are in the one-to-one correspondence with the plurality of first speakers. In other words, the plurality of FB filters are in a one-to-one correspondence with the plurality of FF filters. In this case, the plurality of groups of target noise cancellation parameters further include k^{th}-frame filter coefficients of the plurality of FB filters. In addition, when the headset further includes a downlink compensation filter, the plurality of groups of target noise cancellation parameters further include a k^{th}-frame filter coefficient of the downlink compensation filter. In addition, when k is greater than 1, a target noise canceling level may be further determined. Therefore, the following separately describes the four parts.

It should be noted that the plurality of groups of target noise cancellation parameters may also be referred to as noise cancellation parameters of a plurality of noise cancellation channels, and one noise cancellation channel includes one FF filter and one first speaker. When the headset further includes the plurality of FB filters that are in the one-to-one correspondence with the plurality of first speakers, one noise cancellation channel further includes one FB filter.

(1) Determine the k^{th}-Frame Filter Coefficients of the Plurality of FF Filters.

When k is equal to 1, initial filter coefficients of the plurality of FF filters are determined as the k^{th}-frame filter coefficients of the plurality of FF filters, that is, first-frame filter coefficients of the plurality of FF filters are the initial filter coefficients of the corresponding FF filters, or the k^{th}-frame filter coefficients of the plurality of FF filters are determined based on an initial noise canceling level and a mapping relationship between a noise canceling level and an FF filter coefficient. When k is greater than 1, the k^{th}-frame filter coefficients of the plurality of FF filters are determined based on a (k−1)^{th}-frame reference signal collected by the at least one reference microphone, a (k−1)^{th}-frame error signal collected by the error microphone, and a target noise canceling level. In other words, the k^{th}-frame filter coefficients of the plurality of FF filters are determined according to an adaptation method. The determining process is an adaptation process, and may also be referred to as an iteration process.

It should be noted that the initial filter coefficients of the plurality of FF filters may be the same or may be different, and the initial filter coefficients may be 0 or may not be 0. This is not limited in embodiments of the present disclosure. The initial noise canceling level may be a preset level, and the level is a level at which noise cancellation can be normally performed by using a corresponding noise cancellation coefficient without introducing a stability problem. Certainly, the initial noise canceling level may alternatively be a level determined based on a prompt tone like “Noise cancellation on” or “Dingdong” sent by a user terminal when noise cancellation starts. A noise cancellation coefficient corresponding to the level can better adapt to a current human ear and wearing posture, and a convergence state can be reached more quickly by performing adaptive iteration based on the noise cancellation coefficient corresponding to the level. This is also not limited in embodiments of the present disclosure.

An implementation process of determining the k^{th}-frame filter coefficients of the plurality of FF filters based on the (k−1)^{th}-frame reference signal collected by the at least one reference microphone, the (k−1)^{th}-frame error signal collected by the error microphone, and the target noise canceling level includes: determining (k−1)^{th}-frame filter coefficients of a plurality of SPs based on the target noise canceling level and a mapping relationship between a noise canceling level and a filter coefficient of an SP, where the plurality of SPs are paths from the plurality of first speakers to the error microphone; and determining the k^{th}-frame filter coefficients of the plurality of FF filters based on the (k−1)^{th}-frame reference signal collected by the at least one reference microphone, the (k−1)^{th}-frame error signal collected by the error microphone, and the (k−1)^{th}-frame filter coefficients of the plurality of SPs.

The plurality of SPs may also be referred to as SPs of a plurality of noise cancellation channels. The mapping relationship between the noise canceling level and the filter coefficient of the SP includes a plurality of noise canceling levels. A mapping relationship exists between each noise canceling level and filter coefficients of the plurality of SPs, and mapping relationships between different noise canceling levels and the filter coefficients of the plurality of SPs may be different. Therefore, after the target noise canceling level is determined, the filter coefficients corresponding to the plurality of SPs can be obtained from a mapping relationship between the noise canceling level and the filter coefficient of an SP based on the target noise canceling level, and the obtained filter coefficients are used as the (k−1)^{th}-frame filter coefficients of the plurality of SPs. The same applies to the initial noise canceling level.

The k^{th}-frame filter coefficients of the plurality of FF filters may be determined in a multi-channel linkage manner. In addition, when the headset includes a plurality of FF filters, the headset may further include a plurality of FB filters that are in a one-to-one correspondence with the plurality of first speakers, or may not include the plurality of FB filters. In different cases, manners of determining the k^{th}-frame filter coefficients of the plurality of FF filters are different. The manners are separately described below.

Because processes of determining the k^{th}-frame filter coefficients of the FF filters based on the (k−1)^{th}-frame reference signal collected by the at least one reference microphone, the (k−1)^{th}-frame error signal collected by the error microphone, and the (k−1)^{th}-frame filter coefficients of the plurality of SPs are the same, one of the processes is used as an example for description below. In other words, one of the plurality of FF filters is used as a target FF filter, and a k^{th}-frame filter coefficient of the target FF filter is determined in the following manner. For a process of determining a k^{th}-frame filter coefficient of another FF filter in the plurality of FF filters, refer to the process of determining the k^{th}-frame filter coefficient of the target FF filter.

In a first case, the headset does not include the plurality of FB filters. If the target FF filter is a first FF filter, the k^{th}-frame filter coefficient of the target FF filter is determined based on a (k−1)^{th}-frame reference signal collected by a target reference microphone, the (k−1)^{th}-frame error signal collected by the error microphone, and a (k−1)^{th}-frame filter coefficient of a target SP, where the target reference microphone is a reference microphone corresponding to the target FF filter, and the target SP is a path from a first speaker corresponding to the target FF filter to the error microphone. If the target FF filter is a non-first FF filter, the k^{th}-frame filter coefficient of the target FF filter is determined based on a (k−1)^{th}-frame reference signal collected by a target reference microphone, the (k−1)^{th}-frame error signal collected by the error microphone, the (k−1)^{th}-frame filter coefficients of the plurality of SPs, and k^{th}-frame frequency response information and (k−1)^{th}-frame frequency response information that are of each FF filter before the target FF filter.

When the target FF filter is the first FF filter, a residual error is determined based on the (k−1)^{th}-frame reference signal collected by the target reference microphone and the (k−1)^{th}-frame error signal collected by the error microphone, and k^{th}-frame frequency response information of the target FF filter is determined based on (k−1)^{th}-frame frequency response information of the target FF filter, the (k−1)^{th}-frame filter coefficient of the target SP, and the residual error. The k^{th}-frame filter coefficient of the target FF filter is determined based on the k^{th}-frame frequency response information of the target FF filter.

In some embodiments, one of the plurality of FF filters corresponds to one reference microphone. In other words, the target reference microphone includes one reference microphone. In this case, the residual error is determined according to the following formula (1) based on the (k−1)^{th}-frame reference signal collected by the target reference microphone and the (k−1)^{th}-frame error signal collected by the error microphone.

$${Res}_{k - 1} = \frac{E r {r}_{k - 1}}{R e {f}_{k - 1}} \qquad ( 1 )$$

In the foregoing formula (1), Resₖ₋₁ indicates the residual error, Refₖ₋₁ indicates the (k−1)^{th}-frame reference signal collected by the target reference microphone, and Err indicates the (k−1)^{th}-frame error signal collected by the error microphone.

In some other embodiments, one of the plurality of FF filters corresponds to at least two reference microphones. In other words, the target reference microphone includes at least two reference microphones. In this case, audio mixing is performed on (k−1)^{th}-frame reference signals collected by the at least two reference microphones included in the target reference microphone, to obtain a (k−1)^{th}-frame mixed reference signal. The residual error is determined based on the (k−1)^{th}-frame mixed reference signal and the (k−1)^{th}-frame error signal collected by the error microphone. In this way, a signal-to-noise ratio of a reference signal can be improved.

A manner of determining the residual error based on the (k−1)^{th}-frame mixed reference signal and the (k−1)^{th}-frame error signal collected by the error microphone is similar to the foregoing manner of determining the residual error according to the foregoing formula (1). To be specific, the (k−1)^{th}-frame error signal collected by the error microphone is divided by the (k−1)^{th}-frame mixed reference signal, to obtain the residual error.

In some embodiments, frequency response information of the (k−1)^{th}-frame filter coefficient of the target SP may be determined, and then the k^{th}-frame frequency response information of the target FF filter is determined according to the following formula (2) based on the (k−1)^{th}-frame frequency response information of the target FF filter, the frequency response information of the (k−1)^{th}-frame filter coefficient of the target SP, and the residual error.

$$F {F}_{k} = F {F}_{k - 1} + μ \frac{{Res}_{k - 1}}{S {P}_{k - 1}} \qquad ( 2 )$$

In the foregoing formula (2), FFₖ indicates the k^{th}-frame frequency response information of the target FF filter, FFₖ₋₁ indicates the (k−1)^{th}-frame frequency response information of the target FF filter, μ indicates a step and is preset, and SPₖ₋₁ indicates the frequency response information of the (k−1)^{th}-frame filter coefficient of the target SP.

When the target FF filter is a non-first FF filter, the residual error is determined based on the (k−1)^{th}-frame reference signal collected by the target reference microphone and the (k−1)^{th}-frame error signal collected by the error microphone, and k^{th}-frame frequency response information of the target FF filter is determined based on (k−1)^{th}-frame frequency response information of the target FF filter, the residual error, the (k−1)^{th}-frame filter coefficients of the plurality of SPs, and the k^{th}-frame frequency response information and the (k−1)^{th}-frame frequency response information that are of each FF filter before the target FF filter. The k^{th}-frame filter coefficient of the target FF filter is determined based on the k^{th}-frame frequency response information of the target FF filter.

A manner of determining the residual error is the same as that described above. For a detailed implementation process, refer to the foregoing content.

When the k^{th}-frame frequency response information of the target FF filter is determined, the k^{th}-frame frequency response information of the target FF filter may be determined based on the (k−1)^{th}-frame frequency response information of the target FF filter, the residual error, a (k−1)^{th}-frame filter coefficient of a target SP, the k^{th}-frame frequency response information and the (k−1)^{th}-frame frequency response information that are of each FF filter before the target FF filter, and a (k−1)^{th}-frame filter coefficient of an SP corresponding to each FF filter before the target FF filter.

For example, frequency response information of the (k−1)^{th}-frame filter coefficient of the target SP and frequency response information of the (k−1)^{th}-frame filter coefficient of the SP corresponding to each FF filter before the target FF filter may be determined. Then, the k^{th}-frame frequency response information of the target FF filter is determined according to the following formula (3) based on the (k−1)^{th}-frame frequency response information of the target FF filter, the residual error, the frequency response information of the (k−1)^{th}-frame filter coefficient of the target SP, the k^{th}-frame frequency response information and the (k−1)^{th}-frame frequency response information that are of each FF filter before the target FF filter, and the frequency response information of the (k−1)^{th}-frame filter coefficient of the SP corresponding to each FF filter before the target FF filter.

$$F {F}_{i , k} = F {F}_{i , k - 1} + μ \frac{{Res}_{i , k - 1} - {\sum }_{{j = 1}^{}}^{i - 1} ( {FF}_{j , k} - {FF}_{{j , k - 1}^{}} ) * {SP}_{{j , k - 1}^{}}}{S {P}_{i , k - 1}} \qquad ( 3 )$$

In the foregoing formula (3), FF_{i,k} indicates the k^{th}-frame frequency response information of the target FF filter, that is, the target FF filter is an i^{th} FF filter in the plurality of FF filters, FF_{i,k-1} indicates the (k−1)^{th}-frame frequency response information of the target FF filter, Res_{i,k-1} indicates the residual error, SP_{i,k-1} indicates the frequency response information of the (k−1)^{th}-frame filter coefficient of the target SP, FF_{j,k} indicates k^{th}-frame frequency response information of a j^{th} FF filter before the target FF filter, FF_{j,k-1} indicates (k−1)^{th}-frame frequency response information of the j^{th} FF filter before the target FF filter, and SP_{j,k-1} indicates frequency response information of a (k−1)^{th}-frame filter coefficient of an SP corresponding to the j^{th} FF filter before the target FF filter.

An implementation process of determining the k^{th}-frame filter coefficient of the target FF filter based on the k^{th}-frame frequency response information of the target FF filter includes: establishing a loss function between a filter coefficient variable of the target FF filter and the k^{th}-frame frequency response information of the target FF filter. A value of the filter coefficient variable is determined based on the loss function according to a gradient descent method, and the k^{th}-frame filter coefficient of the target FF filter is determined based on the value of the filter coefficient variable. In other words, the loss function between the filter coefficient variable of the target FF filter and the k^{th}-frame frequency response information of the target FF filter is established. An optimal value of the variable is determined according to the gradient descent method, so that the k^{th}-frame filter coefficient of the target FF filter is determined based on the optimal value of the variable.

A filter coefficient of the target FF filter in each frame is determined according to the gradient descent method. One value of the loss function is determined when the filter coefficient of the target FF filter in each frame is determined. When the value of the loss function reaches a minimum threshold, it is determined that a filter coefficient of the target FF filter reaches a convergence stability condition. For example, for the k^{th}-frame filter coefficient of the target FF filter, when the value of the loss function between the filter coefficient variable and the k^{th}-frame frequency response information of the target FF filter reaches the minimum threshold, it is determined that the k^{th}-frame filter coefficient of the target FF filter reaches the convergence stability condition. When the value of the loss function does not reach the minimum threshold, it is determined that the k^{th}-frame filter coefficient of the target FF filter does not reach the convergence stability condition. The minimum threshold is preset, and may be adjusted based on different requirements in different cases.

Optionally, a filter coefficient of each FF filter includes at least one biquad filter coefficient and one gain. Variables corresponding to the biquad filter coefficient include a filter type, a cut-off frequency, and a quality factor. Certainly, in actual application, the filter coefficient of each FF filter may further include more or fewer other parameters. This is not limited in embodiments of the present disclosure.

The k^{th}-frame filter coefficient of the first FF filter may be determined according to a related algorithm based on the value of the filter coefficient variable. The algorithm is not limited in embodiments of the present disclosure.

In some cases, there is a problem of background noise, namely, noise floor, in a quiet environment. For example, for a semi-open headset, the headset is more likely to have a background noise problem in a quiet environment than an in-ear headset. In addition, strong noise cancellation is not required in the quiet environment, and some people may feel uncomfortable when strong noise cancellation is performed in the quiet environment. In addition, larger noise cancellation strength indicates a stronger negative pressure feeling of a person. Therefore, when the value of the filter coefficient variable is determined according to the gradient descent method, a target noise cancellation amplitude may be dynamically adjusted based on an environmental volume, so that the k^{th}-frame filter coefficient of the target FF filter is determined based on the target noise cancellation amplitude, to improve subjective experience effect of adaptive noise cancellation. In other words, the target noise cancellation amplitude is determined based on a (k−1)^{th}-frame environmental volume and environmental volumes in t frames before a (k−1)^{th} frame, where t is greater than or equal to 1 and less than k−1. The value of the filter coefficient variable is determined based on the target noise cancellation amplitude and the loss function according to the gradient descent method, and the k^{th}-frame filter coefficient of the target FF filter is determined based on the value of the filter coefficient variable.

A target environmental volume is determined based on the (k−1)^{th}-frame environmental volume and the environmental volumes in the t frames before the (k−1)^{th} frame. If the target environmental volume is less than or equal to a first volume threshold, a first noise cancellation amplitude is determined as the target noise cancellation amplitude. If the target environmental volume is greater than the first volume threshold, it is determined whether the target environmental volume is significantly increased or significantly decreased, and if the target environmental volume is significantly increased, a (k−1)^{th}-frame noise cancellation amplitude is increased, to obtain the target noise cancellation amplitude. If the environmental volume is significantly decreased, the (k−1)^{th}-frame noise cancellation amplitude is decreased, to obtain the target noise cancellation amplitude. If the target environmental volume is not significantly increased and is not significantly decreased, the (k−1)^{th}-frame noise cancellation amplitude is determined as the target noise cancellation amplitude, that is, the noise cancellation amplitude remains unchanged.

There are a plurality of manners of determining the target environmental volume based on the (k−1)^{th}-frame environmental volume and the environmental volumes in the t frames before the (k−1)^{th} frame, for example, obtaining an arithmetic average value or a weighted average value. This is not limited in embodiments of the present disclosure. The t frames may be any t frames before the (k−1)^{th} frame, or may be t frames that are before the (k−1)^{th} frame and that are closest to the (k−1)^{th} frame. This is not limited in embodiments of the present disclosure.

It should be noted that the first volume threshold is preset, and the first volume threshold indicates whether an environment is currently quiet. In other words, if the target environmental volume is less than or equal to the first volume threshold, it indicates that the environment is quiet. If the target environmental volume is greater than the first volume threshold, it indicates that the environment is not quiet. The first noise cancellation amplitude is preset for a quiet environment, and is used to perform weak noise cancellation, so as to avoid excessively amplifying background noise or introducing a subjective comfort problem. In actual application, the first volume threshold and the first noise cancellation amplitude may be adjusted based on different requirements.

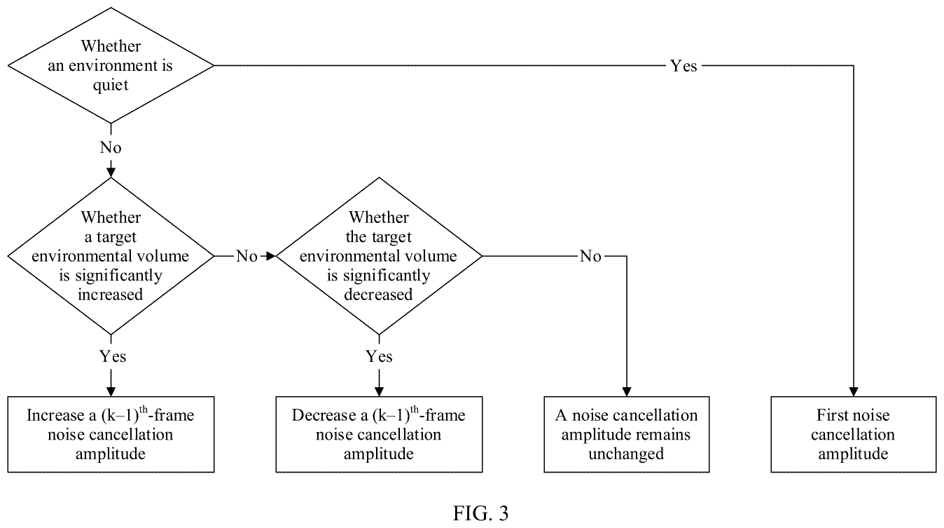

For example, refer to FIG. 3. Whether the environment is quiet is determined based on the target environmental volume, and when the environment is quiet, the first noise cancellation amplitude is determined as the target noise cancellation amplitude. In the non-quiet environment, if the target environmental volume significantly increases, the (k−1)^{th}-frame noise cancellation amplitude is increased, to obtain the target noise cancellation amplitude. If the target environmental volume is significantly decreased, the (k−1)^{th}-frame noise cancellation amplitude is decreased, to obtain the target noise cancellation amplitude. If the target environmental volume is not significantly increased and is not significantly decreased, the (k−1)^{th}-frame noise cancellation amplitude is determined as the target noise cancellation amplitude, that is, the noise cancellation amplitude remains unchanged.

There are a plurality of manners of determining whether the target environmental volume is significantly increased or significantly decreased. For example, if a target environmental volume determined this time is greater than a target environmental volume determined last time, and a difference between the target environmental volume determined this time and the target environmental volume determined last time is greater than a second volume threshold, it is determined that the target environmental volume determined this time is significantly increased. Similarly, if the target environmental volume determined this time is less than the target environmental volume determined last time, and the difference between the target environmental volume determined this time and the target environmental volume determined last time is greater than the second volume threshold, it is determined that the target environmental volume determined this time is significantly decreased.

The second volume threshold is also preset, for example, 3 dB. In actual application, the second volume threshold may be further adjusted based on different requirements.

In a second case, the headset further includes the plurality of FB filters. If the target FF filter is a first FF filter, the k^{th}-frame filter coefficient of the target FF filter is determined based on a (k−1)^{th}-frame reference signal collected by a target reference microphone, the (k−1)^{th}-frame error signal collected by the error microphone, the (k−1)^{th}-frame filter coefficients of the plurality of SPs, and the (k−1)^{th}-frame filter coefficients of the plurality of FB filters. If the target FF filter is a non-first FF filter, the k^{th}-frame filter coefficient of the target FF filter is determined based on a (k−1)^{th}-frame reference signal collected by a target reference microphone, the (k−1)^{th}-frame error signal collected by the error microphone, the (k−1)^{th}-frame filter coefficients of the plurality of SPs, the (k−1)^{th}-frame filter coefficients of the plurality of FB filters, and k^{th}-frame frequency response information and (k−1)^{th}-frame frequency response information that are of each FF filter before the target FF filter.

When the target FF filter is the first FF filter, the residual error may be determined based on the (k−1)^{th}-frame reference signal collected by the target reference microphone and the (k−1)^{th}-frame error signal collected by the error microphone, and k^{th}-frame frequency response information of the target FF filter is determined based on (k−1)^{th}-frame frequency response information of the target FF filter, the residual error, the (k−1)^{th}-frame filter coefficients of the plurality of FB filters, and the (k−1)^{th}-frame filter coefficients of the plurality of SPs. The k^{th}-frame filter coefficient of the target FF filter is determined based on the k^{th}-frame frequency response information of the target FF filter.

In an example, frequency response information of the (k−1)^{th}-frame filter coefficients of the plurality of FB filters and frequency response information of the (k−1)^{th}-frame filter coefficients of the plurality of SPs may be determined. Then, the k^{th}-frame frequency response information of the target FF filter is determined according to the following formula (4) based on the (k−1)^{th}-frame frequency response information of the target FF filter, the residual error, the frequency response information of the (k−1)^{th}-frame filter coefficients of the plurality of FB filters, and the frequency response information of the (k−1)^{th}-frame filter coefficients of the plurality of SPs.

$$F {F}_{1 , k} = F {F}_{1 , k - 1} + μ \frac{{Res}_{1 , k - 1}}{S {P}_{1 , k - 1}} * ( 1 + {\sum }_{{j = 1}^{}}^{n} F {B}_{{j , k - 1}^{}} * {SP}_{{j , k - 1}^{}} ) \qquad ( 4 )$$

In the foregoing formula (4), FF_{1,k} indicates the k^{th}-frame frequency response information of the target FF filter, FF_{1,k-1} indicates the (k−1)^{th}-frame frequency response information of the target FF filter, Res_{1,k-1} indicates the residual error, SP_{1,k-1} indicates frequency response information of the (k−1)^{th}-frame filter coefficient of the target SP, FB_{j,k-1} indicates frequency response information of a (k−1)^{th}-frame filter coefficient of a j^{th} FB filter in the plurality of FB filters, SP_{j,k-1} indicates frequency response information of a (k−1)^{th}-frame filter coefficient of an SP corresponding to the j^{th} FB filter, and n indicates a total quantity of the plurality of FB filters, namely, a total quantity of the plurality of noise cancellation channels.

When the target FF filter is the non-first FF filter, the residual error may be determined based on the (k−1)^{th}-frame reference signal collected by the target reference microphone and the (k−1)^{th}-frame error signal collected by the error microphone, and k^{th}-frame frequency response information of the target FF filter is determined based on (k−1)^{th}-frame frequency response information of the target FF filter, the residual error, the (k−1)^{th}-frame filter coefficients of the plurality of SPs, the (k−1)^{th}-frame filter coefficients of the plurality of FB filters, and k^{th}-frame frequency response information and (k−1)^{th}-frame frequency response information that are of each FF filter before the target FF filter. The k^{th}-frame filter coefficient of the target FF filter is determined based on the k^{th}-frame frequency response information of the target FF filter.

In an example, frequency response information of the (k−1)^{th}-frame filter coefficients of the plurality of SPs and frequency response information of the (k−1)^{th}-frame filter coefficients of the plurality of FB filters may be determined. Then, the k^{th}-frame frequency response information of the target FF filter is determined according to the following formula (5) based on the (k−1)^{th}-frame frequency response information of the target FF filter, the residual error, the frequency response information of the (k−1)^{th}-frame filter coefficients of the plurality of SPs, the frequency response information of the (k−1)^{th}-frame filter coefficients of the plurality of FB filters, and the k^{th}-frame frequency response information and the (k−1)^{th}-frame frequency response information that are of each FF filter before the target FF filter.

$$F {F}_{i , k} = F {F}_{i , k - 1} + μ \frac{{Res}_{i , k - 1} * ( 1 + {\sum }_{j = 1}^{n} {FB}_{j , k - 1} * {SP}_{j , k - 1} ) - {\sum }_{j = 1}^{i - 1} ( {FF}_{j , k} - {FF}_{j , k - 1} ) * {SP}_{j , k - 1}}{S {P}_{i , k - 1}} \qquad ( 5 )$$

In the foregoing formula (5), FB_{j,k-1} indicates frequency response information of a (k−1)^{th}-frame filter coefficient of a j^{th} FB filter in the plurality of FB filters, n indicates a total quantity of the plurality of FB filters, namely, a total quantity of the plurality of noise cancellation channels, and meanings represented by other letters are the same as those in the foregoing formula (3).

An implementation process of determining the k^{th}-frame filter coefficient of the target FF filter based on the k^{th}-frame frequency response information of the target FF filter is the same as that in the first case. For detailed content, refer to the foregoing descriptions. In addition, frequency response information of filter coefficients of the SPs may be determined according to a related algorithm based on the filter coefficients of the SP, and frequency response information of FB filter coefficients may also be determined according to a related algorithm based on filter coefficients of the FB filters. The algorithm is not limited in embodiments of the present disclosure.

In the foregoing processes of determining the k^{th}-frame frequency response information of the target FF filter, regardless of whether the headset includes a target FB filter, the k^{th}-frame frequency response information of the target FF filter is determined based on the (k−1)^{th}-frame filter coefficient of the target SP, and the (k−1)^{th}-frame filter coefficient of the target SP is determined based on the target noise canceling level by querying the mapping relationship between the noise canceling level and the filter coefficient of the SP. To be specific, the (k−1)^{th}-frame filter coefficient of the target SP is an estimated value, and the k^{th}-frame frequency response information of the target FF filter is determined based on the estimated value, so that dependence on a real value of the target SP can be eliminated, and adaptation of filter coefficients of FF filters can also be implemented when there is no downlink signal.

(2) Determine the k^{th}-Frame Filter Coefficients of the Plurality of FB Filters.

When k is equal to 1, initial filter coefficients of the plurality of FB filters are determined as the k^{th}-frame filter coefficients of the plurality of FB filters, that is, first-frame filter coefficients of the plurality of FB filters are the initial filter coefficients of the corresponding FB filters, or the k^{th}-frame filter coefficients of the plurality of FB filters are determined based on an initial noise canceling level and a mapping relationship between a noise canceling level and an FB filter coefficient. When k is greater than 1, the k^{th}-frame filter coefficients of the plurality of FB filters may be determined based on the target noise canceling level.

It should be noted that the initial filter coefficients of the plurality of FB filters may be the same or may be different, and the initial filter coefficients may be 0 or may not be 0. This is not limited in embodiments of the present disclosure.

Because processes of determining k^{th}-frame filter coefficients of the FB filters based on the target noise canceling level are the same, one of the processes is used as an example for description below. In other words, one of the plurality of FB filters is used as a target FB filter, and a k^{th}-frame filter coefficient of the target FB filter is determined in the following two manners. For a process of determining a k^{th}-frame filter coefficient of another FB filter in the plurality of FB filters, refer to the process of determining the k^{th}-frame filter coefficient of the target FB filter. In other words, when k is greater than 1, the k^{th}-frame filter coefficient of the target FB filter may be determined in the following two manners.

In a first manner, the k^{th}-frame filter coefficient of the target FB filter is determined based on the target noise canceling level and the mapping relationship between the noise canceling level and the FB filter coefficient.

The mapping relationship between the noise canceling level and the FB filter coefficient includes a plurality of noise canceling levels, a mapping relationship exists between each noise canceling level and filter coefficients of the plurality of FB filters, and mapping relationships between different noise canceling levels and the filter coefficients of the plurality of FB filters may be different. Therefore, a filter coefficient corresponding to the target FB filter can be obtained from the mapping relationship between the noise canceling level and the FB filter coefficient based on the target noise canceling level, and the obtained filter coefficient is used as the k^{th}-frame filter coefficient of the target FB filter.

Because the mapping relationship between the noise canceling level and the FB filter coefficient is stored in advance, determining the k^{th}-frame filter coefficient of the target FB filter in the first manner is stable, an operation is simple, and efficiency is high.

In a second manner, if the target FB filter is a first-type FB filter, the k^{th}-frame filter coefficient of the target FB filter is determined based on the target noise canceling level and the mapping relationship between the noise canceling level and the FB filter coefficient. If the target FB filter is a second-type FB filter, the k^{th}-frame filter coefficient of the target FB filter is determined based on the (k−1)^{th}-frame error signal collected by the error microphone, the (k−1)^{th}-frame filter coefficient of the target FB filter, and the target noise canceling level.

Similar to the foregoing descriptions, when the target FB filter is the second-type FB filter, the k^{th}-frame filter coefficient of the target FB filter may be determined according to the adaptation method. The process of determining the k^{th}-frame filter coefficient of the target FB filter is an adaptation process, and may also be referred to as an iteration process.

An implementation process of determining the k^{th}-frame filter coefficient of the target FB filter based on the (k−1)^{th}-frame error signal collected by the error microphone, the (k−1)^{th}-frame filter coefficient of the target FB filter, and the target noise canceling level includes: determining a (k−1)^{th}-frame filter coefficient of a target SP based on the target noise canceling level and a mapping relationship between a noise canceling level and a filter coefficient of an SP, where the target SP is a path from a first speaker corresponding to the target FB filter to the error microphone; and determining the k^{th}-frame filter coefficient of the target FB filter based on the (k−1)^{th}-frame error signal collected by the error microphone, the (k−1)^{th}-frame filter coefficient of the target FB filter, and the (k−1)^{th}-frame filter coefficient of the target SP.

The k^{th}-frame filter coefficient of the target FB filter may be determined according to a related algorithm based on the (k−1)^{th}-frame error signal collected by the error microphone, the (k−1)^{th}-frame filter coefficient of the target FB filter, and the (k−1)^{th}-frame filter coefficient of the target SP. The algorithm is not limited in embodiments of the present disclosure.

A first-frame filter coefficient of the target FB filter may be an initial filter coefficient, or may be determined based on the initial noise canceling level by querying the mapping relationship between the noise canceling level and the FB filter coefficient. Therefore, when k is greater than or equal to 1, it is equivalent to that the k^{th}-frame filter coefficient of the target FB filter may be determined in three manners. To be specific, (1) the k^{th}-frame filter coefficient of the target FB filter is determined by querying the mapping relationship between the noise canceling level and the FB filter coefficient. (2) If the target FB filter is the first-type FB filter, the k^{th}-frame filter coefficient of the target FB filter is determined by querying the mapping relationship between the noise canceling level and the FB filter coefficient. If the target FB filter is the second-type FB filter, the k^{th}-frame filter coefficient of the target FB filter is determined based on the (k−1)^{th}-frame error signal collected by the error microphone, the (k−1)^{th}-frame filter coefficient of the target FB filter, and the target noise canceling level. (3) If the target FB filter is the first-type FB filter, or the target FB filter is the second-type FB filter and k is equal to 1, the k^{th}-frame filter coefficient of the target FB filter is determined by querying the mapping relationship between the noise canceling level and the FB filter coefficient. If the target FB filter is the second-type FB filter and k is greater than 1, the k^{th}-frame filter coefficient of the target FB filter is determined based on the (k−1)^{th}-frame error signal collected by the error microphone, the (k−1)^{th}-frame filter coefficient of the target FB filter, and the target noise canceling level.

A sound-making frequency band of a first speaker corresponding to the first-type FB filter is higher than a sound-making frequency band of a first speaker corresponding to the second-type FB filter. In other words, the first speaker corresponding to the first-type FB filter is a high-band speaker, and the first speaker corresponding to the second-type FB filter is a low-band speaker. Certainly, the first-type FB filter and the second-type FB filter may not be distinguished based on a sound-making frequency band, but may be distinguished in another manner. This is also not limited in embodiments of the present disclosure.

In the foregoing second manner and third manner, a manner of querying the mapping relationship between the noise canceling level and the FB filter coefficient is combined with an adaptive manner, so that noise cancellation effect can be improved, complexity is not high, and stability is controllable.

It should be noted that, in embodiments of the present disclosure, the k^{th}-frame filter coefficient of the target FB filter may be determined in the foregoing three manners, and the k^{th}-frame filter coefficient of the target FB filter may alternatively be determined in another manner. For example, regardless of whether the target FB filter is the first-type FB filter or the second-type FB filter, the k^{th}-frame filter coefficient of the target FB filter is determined based on the (k−1)^{th}-frame error signal collected by the error microphone, the (k−1)^{th}-frame filter coefficient of the target FB filter, and the target noise canceling level. This is not limited in embodiments of the present disclosure.

(3) Determine the k^{th}-Frame Filter Coefficient of the Downlink Compensation Filter.

When k is equal to 1, an initial downlink compensation filter coefficient is determined as the k^{th}-frame filter coefficient of the downlink compensation filter, or the k^{th}-frame filter coefficient of the downlink compensation filter is determined based on an initial noise canceling level and a mapping relationship between a noise canceling level and a downlink compensation filter coefficient. When k is greater than 1, the k^{th}-frame filter coefficient of the downlink compensation filter is determined based on the target noise canceling level and the mapping relationship between the noise canceling level and the downlink compensation filter coefficient.

The mapping relationship between the noise canceling level and the downlink compensation filter coefficient includes a plurality of noise canceling levels, a mapping relationship exists between each noise canceling level and a filter coefficient of the downlink compensation filter, and mapping relationships between different noise canceling levels and filter coefficients of the downlink compensation filter may be different. Therefore, after the target noise canceling level is determined, a corresponding downlink compensation filter coefficient can be obtained from the mapping relationship between the noise canceling level and the downlink compensation filter coefficient based on the target noise canceling level, and the obtained downlink compensation filter coefficient is used as the k^{th}-frame filter coefficient of the downlink compensation filter.

### (4) Determine the Target Noise Canceling Level.

A (k−1)^{th}-frame noise canceling level is determined, and noise canceling levels in m frames before a (k−1)^{th} frame are obtained, where m is greater than or equal to 1 and less than k−1. The target noise canceling level is determined based on the (k−1)^{th}-frame noise canceling level and the noise canceling levels in the m frames.

In the (k−1)^{th} frame, a valid downlink signal may exist, or no valid downlink signal may exist, and an environment may be quiet, or an environment may not be quiet, or certainly, an abnormal signal may exist. In different cases, manners of determining the (k−1)^{th}-frame noise canceling level are different, and are separately described below.

In a first case, in the (k−1)^{th} frame, no valid downlink signal exists and the environment is not quiet. In this case, the (k−1)^{th}-frame noise canceling level is determined based on reference filter coefficients of the plurality of FF filters and a mapping relationship between a noise canceling level and frequency response information of an FF filter. When k is equal to 2, the reference filter coefficients are initial filter coefficients of the corresponding FF filters; or when k is greater than 2, the reference filter coefficients are filter coefficients that are of the corresponding FF filters and that meet a convergence stability condition last time before a k^{th} frame, or are (k−1)^{th}-frame filter coefficients of the corresponding FF filters.

When an audio signal is played through the headset, for example, music is played or a call is made, a user terminal delivers control signaling for playing the audio signal to the headset. Therefore, whether the headset is currently in a downlink enabled state may be determined based on whether the headset receives the control signaling. When the headset is not in the downlink enabled state, it is determined that no valid downlink signal exists in the (k−1)^{th} frame. When the headset is in the downlink enabled state, there may not necessarily be a sound continuously output in the (k−1)^{th} frame. For example, no sound is output in a pause period of a speech, a transition period of music change, and the like, and the time is usually not short. Therefore, when the headset is in the downlink enabled state, it may be further determined whether the (k−1)^{th} frame is in a downlink intermittent period. If the (k−1)^{th} frame is in the downlink intermittent period, it is determined that no valid downlink signal exists in the (k−1)^{th} frame. If the (k−1)^{th} frame is not in a downlink intermittent period, it is determined that the valid downlink signal exists in the (k−1)^{th} frame.

When no valid downlink signal exists in the (k−1)^{th} frame but the environment is not quiet, the (k−1)^{th}-frame noise canceling level may vary with different environmental noise. Therefore, the (k−1)^{th}-frame noise canceling level needs to be determined based on the reference filter coefficients of the plurality of FF filters and the mapping relationship between the noise canceling level and the frequency response information of the FF filter.

In some embodiments, reference frequency response information of the plurality of FF filters is determined based on the reference filter coefficients of the plurality of FF filters. Noise canceling levels matching the reference frequency response information of the plurality of FF filters are determined based on the mapping relationship between the noise canceling level and the frequency response information of the FF filter, to obtain a plurality of reference noise canceling levels. The (k−1)^{th}-frame noise canceling level is determined based on the plurality of reference noise canceling levels.

The reference frequency response information of the plurality of FF filters may be determined according to a related algorithm based on the reference filter coefficients of the plurality of FF filters. The algorithm is not limited in embodiments of the present disclosure.

When the noise canceling levels are different, the frequency response information of the FF filters may also be different. Therefore, the mapping relationship between the noise canceling level and the frequency response information of the FF filter may be stored in advance. In this way, after the reference frequency response information of the plurality of FF filters is determined, for any one of the plurality of FF filters, matching is performed between reference frequency response information of the FF filter and frequency response information of the FF filter at different noise canceling levels in the mapping relationship, to determine, from the mapping relationship, frequency response information matching the reference frequency response information of the FF filter, and then use a noise canceling level corresponding to the matched frequency response information as a reference noise canceling level. Other FF filters in the plurality of FF filters are processed in a same manner, so that a plurality of reference noise canceling levels can be obtained.

The frequency response information of the FF filter may be represented by using a frequency response curve. Therefore, after reference frequency response curves of the plurality of FF filters are determined, for any one of the plurality of FF filters, matching is performed between a reference frequency response curve of the FF filter and frequency response curves of the FF filter at the different noise canceling levels in the mapping relationship.

In actual application, matching may be performed between the complete reference frequency response curve of the FF filter and the complete frequency response curves of the FF filter at the different noise canceling levels in the mapping relationship. Alternatively, matching may be performed between a curve that is in the reference frequency response curve of the FF filter and that is in a target frequency band and curves that are in the frequency response curves of the FF filter at the different noise canceling levels in the mapping relationship and that are in the target frequency band. This is not limited in embodiments of the present disclosure.

It should be noted that the target frequency band is a frequency band with obvious distinguishing features in the frequency response curves, and the target frequency band is preset. For example, the target frequency band is a frequency band from 100 hertz (Hz) to 200 Hz. Certainly, in different acoustic conditions of the headset, values of the target frequency band may also be different.

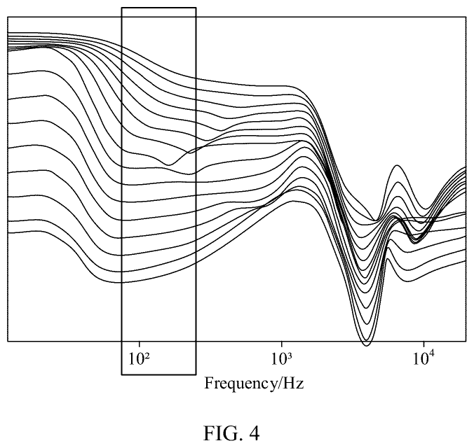

For example, the mapping relationship between the noise canceling level and the frequency response information of the FF filter includes frequency response curves of the FF filter at 16 noise canceling levels, and the frequency response curves of the FF filter at the 16 noise canceling levels are shown in FIG. 4. Because features in the frequency band from 100 Hz to 200 Hz in FIG. 4 are obviously distinguished, the frequency band from 100 Hz to 200 Hz is used as the target frequency band. Then, matching is performed between a curve that is in the reference frequency response curve of the FF filter and that falls within a range from 100 Hz to 200 Hz and curves that are in the frequency response curves of the FF filter at the 16 noise canceling levels and that fall within the range from 100 Hz to 200 Hz.

There are a plurality of manners of determining the (k−1)^{th}-frame noise canceling level based on the plurality of reference noise canceling levels. For example, the (k−1)^{th}-frame noise canceling level is determined based on an average value of the plurality of reference noise canceling levels. Alternatively, the (k−1)^{th}-frame noise canceling level is determined based on a reference noise canceling level with a largest quantity in the plurality of reference noise canceling levels.

When the (k−1)^{th}-frame noise canceling level is determined based on the average value of the plurality of reference noise canceling levels, the average value of the plurality of reference noise canceling levels may be directly determined as the (k−1)^{th}-frame noise canceling level, or the average value of the plurality of reference noise canceling levels may be adjusted to obtain the (k−1)^{th}-frame noise canceling level. Similarly, when the (k−1)^{th}-frame noise canceling level is determined based on the reference noise canceling level with the largest quantity in the plurality of reference noise canceling levels, the reference noise canceling level with the largest quantity in the plurality of reference noise canceling levels may be directly determined as the (k−1)^{th}-frame noise canceling level, or the reference noise canceling level with the largest quantity in the plurality of reference noise canceling levels may be adjusted to obtain the (k−1)^{th}-frame noise canceling level. This is not limited in embodiments of the present disclosure.

Because a process of determining a filter coefficient of the FF filter is an iteration process, and may also be referred to as an adaptation process, the foregoing convergence stability condition indicates that the filter coefficient of the FF filter converges to basically remain unchanged. In addition, because the filter coefficient of the FF filter may be adaptively adjusted a plurality of times in the entire noise cancellation process, when a k^{th}-frame filter coefficient of the FF filter is determined, a filter coefficient that is of the FF filter and that meets the convergence stability condition last time before the k^{th} frame may be used as a reference filter coefficient, or a (k−1)^{th}-frame filter coefficient of the FF filter may be used as a reference filter coefficient.

In a second case, the valid downlink signal exists in the (k−1)^{th} frame. In this case, the (k−1)^{th}-frame noise canceling level is determined based on the (k−1)^{th}-frame valid downlink signal, a (k−1)^{th}-frame reference signal collected by the at least one reference microphone, and a (k−1)^{th}-frame error signal collected by the error microphone.

In view of the foregoing descriptions, when the headset is in a downlink enabled state and is not in a downlink intermittent period, it is determined that the valid downlink signal exists in the (k−1)^{th} frame. In this case, a valid downlink signal may be extracted from the (k−1)^{th}-frame error signal collected by the error microphone based on the (k−1)^{th}-frame valid downlink signal, the (k−1)^{th}-frame reference signal collected by the at least one reference microphone, and the (k−1)^{th}-frame error signal collected by the error microphone, to determine the (k−1)^{th}-frame noise canceling level based on the extracted valid downlink signal.

The valid downlink signal may be extracted from the (k−1)^{th}-frame error signal collected by the error microphone according to a related algorithm based on the (k−1)^{th}-frame valid downlink signal, the (k−1)^{th}-frame reference signal collected by the at least one reference microphone, and the (k−1)^{th}-frame error signal collected by the error microphone, to determine the (k−1)^{th}-frame noise canceling level based on the extracted valid downlink signal. The algorithm is not limited in embodiments of the present disclosure.

In a third case, in the (k−1)^{th} frame, no valid downlink signal exists and the environment is quiet, or the abnormal noise signal exists in the (k−1)^{th} frame. In this case, a (k−3)^{th}-frame noise canceling level is determined as the (k−1)^{th}-frame noise canceling level. In other words, the noise canceling level remains unchanged.

In the (k−1)^{th} frame, when no valid downlink signal exists and the environment is quiet, noise basically does not change. In this case, the noise canceling level may remain unchanged. When the abnormal noise signal exists in the (k−1)^{th} frame, the noise canceling level remains unchanged, to perform robustness control, and avoid divergence of the noise canceling level.

The abnormal noise signal indicates a signal that has a severe impact on user listening experience, for example, howling, clipping, background noise, and wind noise. Howling is a phenomenon in which an amplitude or energy of a single-frequency sound signal suddenly increases from a small value, and is usually caused by an action like squeezing a headset, or quickly changing a wearing posture of a headset by a user. A sound signal emitted during howling is referred to as howling noise. Howling causes user discomfort, interferes with playing of a downlink signal, and seriously affects audio playing effect. Clipping is a phenomenon in which a low-band signal overflows and generates crack noise, and the generated crack noise is referred to as clipping noise. Generally, clipping occurs when low-band large noise bursts in an environment. For example, low-band large noise is generated when a vehicle is bumped or an airplane is landed. The background noise is ground noise, and the background noise may also be referred to as noise floor. The background noise is noise caused by performance limitation of hardware (for example, a circuit or another component in a headset) of a device, for example, a rustling sound other than a program sound in a television sound. In a noisy environment, background noise cannot be perceived or heard by a user. When the environment is quiet, the user can perceive the background noise. Too strong background noise not only annoys people, but also submerges weak details in a sound. The wind noise is generated when there is wind in an environment. The wind noise affects normal use of a headset by a user. In addition, because a direction of the wind noise is randomized, impact of the wind noise on ears of the user is different. In other words, the left ear and the right ear have different hearing feelings under the impact of the wind noise.

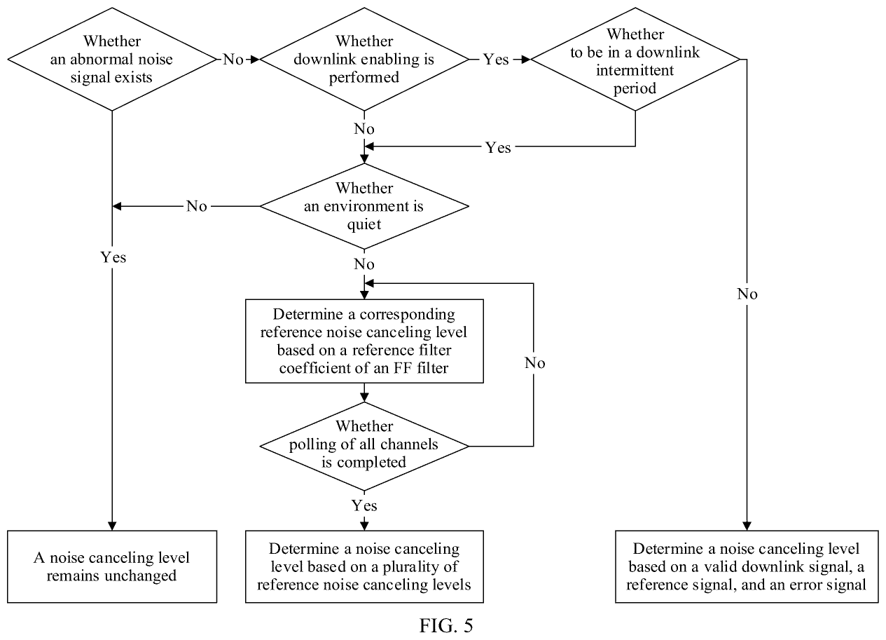

The following briefly summarizes the foregoing three cases with reference to FIG. 5. Refer to FIG. 5, when the abnormal noise signal exists in the (k−1)^{th} frame, the noise canceling level remains unchanged. When no abnormal noise signal exists in the (k−1)^{th} frame, it is determined whether downlink enabling is performed in the (k−1)^{th} frame. When downlink enabling is not performed in the (k−1)^{th} frame, it is determined whether the environment is quiet in the (k−1)^{th} frame. When the environment is quiet in the (k−1)^{th} frame, the noise canceling level remains unchanged. When the environment is not quiet in the (k−1)^{th} frame, a corresponding reference noise canceling level is determined based on a reference filter coefficient of an FF filter, and after polling of all channels is completed, the (k−1)^{th}-frame noise canceling level is determined based on a plurality of reference noise canceling levels. When downlink enabling is performed in the (k−1)^{th} frame, it is determined whether the (k−1)^{th} frame is in a downlink intermittent period. When the (k−1)^{th} frame is in the downlink intermittent period, a plurality of reference noise canceling levels are determined in the same manner, and then the (k−1)^{th}-frame noise canceling level is determined based on the plurality of reference noise canceling levels. When the (k−1)^{th} frame is not in the downlink intermittent period, the (k−1)^{th}-frame noise canceling level is determined based on a (k−1)^{th}-frame valid downlink signal, the (k−1)^{th}-frame reference signal collected by the at least one reference microphone, and the (k−1)^{th}-frame error signal collected by the error microphone.

After the (k−1)^{th}-frame noise canceling level is determined in the foregoing three cases, the (k−1)^{th}-frame noise canceling level and the noise canceling levels in the m frames before the (k−1)^{th} frame may be integrated, to determine the target noise canceling level.

The noise canceling levels in the m frames may be noise canceling levels in any m frames before the (k−1)^{th} frame, or may be noise canceling levels in m frames that are before the (k−1)^{th} frame and that are closest to the (k−1)^{th} frame. This is not limited in embodiments of the present disclosure. In addition, there are a plurality of implementations of determining the target noise canceling level based on the (k−1)^{th}-frame noise canceling level and the noise canceling levels in the m frames before the (k−1)^{th} frame. For example, noise cancellation effect is evaluated according to a related algorithm, to determine a noise cancellation probability corresponding to the (k−1)^{th}-frame noise canceling level and noise cancellation probabilities corresponding to the noise canceling levels in the m frames, and determine a noise canceling level with a largest noise cancellation probability as the target noise canceling level. Alternatively, an arithmetic average value or a weighted average value of the (k−1)^{th}-frame noise canceling level and the noise canceling levels in the m frames is determined, to obtain the target noise canceling level. Alternatively, a noise canceling level that appears most frequently in the (k−1)^{th}-frame noise canceling level and the noise canceling levels in the m frames is determined as the target noise canceling level, or the like.

The foregoing various mapping relationships are determined in advance. For example, when one of the plurality of first speakers works and the other first speakers do not work, the various mapping relationships are determined based on a reference signal collected by the at least one reference microphone and an error signal collected by the error microphone in each of a plurality of leakage states. The plurality of leakage states are formed by the headset and a plurality of different ear canal environments, and the plurality of leakage states are in a one-to-one correspondence with a plurality of noise canceling levels.

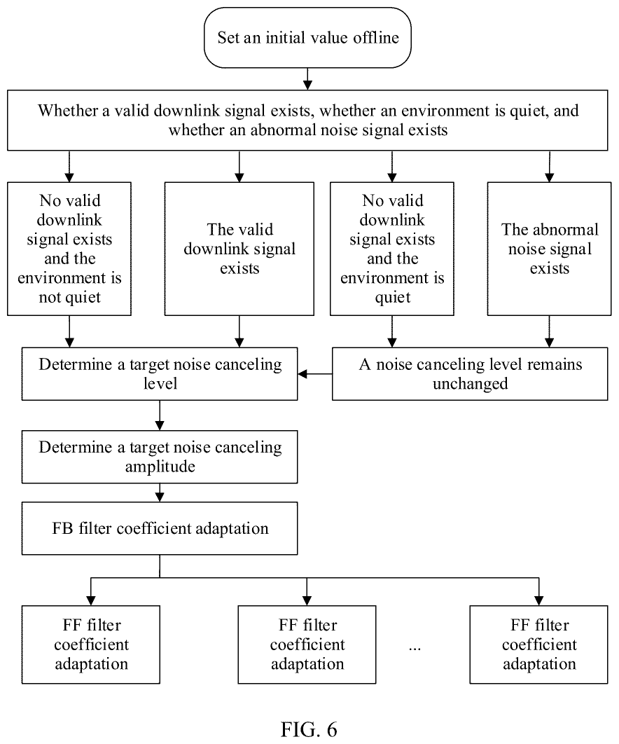

In this case, the plurality of groups of target noise cancellation parameters have been determined. A process of determining the plurality of groups of target noise cancellation parameters is briefly summarized below by using FIG. 6 as an example. Refer to FIG. 6. An initial value, including the foregoing initial noise canceling level, initial filter coefficient, and various mapping relationships, may be set offline. Then, in the (k−1)^{th} frame, it is determined whether the valid downlink signal exists, whether the environment is quiet, and whether the abnormal noise signal exists, to determine the (k−1)^{th}-frame noise canceling level based on different cases. The target noise canceling level is determined based on the (k−1)^{th}-frame noise canceling level and the previous noise canceling levels in the m frames. Then, a target noise cancellation amplitude is determined based on a (k−1)^{th}-frame environmental volume, and FB filter coefficient adaptation is performed based on the target noise canceling level, to determine the k^{th}-frame filter coefficients of the plurality of FB filters. Finally, FF filter coefficient adaptation is performed based on the target noise canceling level and the target noise cancellation amplitude, to determine the k^{th}-frame filter coefficient of the plurality of FF filters.

Step 202: Generate, based on the plurality of groups of target noise cancellation parameters, a plurality of groups of target inverse phase noise that are in a one-to-one correspondence with the plurality of first speakers, where a frequency band of each target inverse phase noise in the plurality of groups of target inverse phase noise covers a sound-making frequency band of the plurality of first speakers.

In view of the foregoing descriptions, the plurality of groups of target noise cancellation parameters may be referred to as noise cancellation parameters of the plurality of noise cancellation channels. In this way, the generated plurality of groups of target inverse phase noise may also be referred to as inverse phase noise of the plurality of noise cancellation channels. Because processes of generating inverse phase noise of the noise cancellation channels are the same, the following uses one of the noise cancellation channels as an example for description.

One of the plurality of noise cancellation channels is used as a target noise cancellation channel, the target noise cancellation channel includes a target FF filter and a target first speaker, and a reference microphone corresponding to the target FF filter is referred to as a target reference microphone. In this case, the target inverse phase noise includes feedforward inverse phase noise. In other words, a k^{th}-frame reference signal collected by the target reference microphone is processed based on a k^{th}-frame filter coefficient of the target FF filter, to obtain the feedforward inverse phase noise.

In view of the foregoing descriptions, the target reference microphone may include one reference microphone, or may include at least two reference microphones. When the target reference microphone includes one reference microphone, the k^{th}-frame reference signal collected by the target reference microphone may be processed directly based on the k^{th}-frame filter coefficient of the target FF filter, to obtain the feedforward inverse phase noise. When the target reference microphone includes at least two reference microphones, audio mixing is performed on k^{th}-frame reference signals collected by the at least two reference microphones, to obtain a k^{th}-frame mixed reference signal, and then the k^{th}-frame mixed reference signal is processed based on the k^{th}-frame filter coefficient of the target FF filter, to obtain the feedforward inverse phase noise.

When the headset further includes an FB filter, the target noise cancellation channel further includes a target FB filter. In this case, the target inverse phase noise further includes feedback inverse phase noise. In other words, downlink compensation is performed, based on the k^{th}-frame filter coefficient of the downlink compensation filter, on a k^{th}-frame downlink signal sent by the user terminal. Then, after negation is performed on a k^{th}-frame downlink signal obtained through downlink compensation, audio mixing is performed on a negated k^{th}-frame downlink signal and a k^{th}-frame error signal collected by the error microphone, to obtain a k^{th}-frame noise signal collected by the error microphone. The k^{th}-frame noise signal collected by the error microphone is processed based on the k^{th}-frame filter coefficient of the target FB filter, to obtain the feedback inverse phase noise.

Downlink compensation can be used to remove all downlink signals in error signals collected by the error microphone, so that noise cancellation is performed only on a residual noise signal through the FB filter, to avoid a sound quality damage to the downlink signals. In addition, downlink compensation is performed on the k^{th}-frame downlink signal sent by the user terminal, so that downlink signals of all speakers at the error microphone can be removed, to avoid a sound quality damage to full-band downlink signals.

In view of the foregoing descriptions, when the plurality of groups of target noise cancellation parameters are determined on a per-frame basis, because one frame may include one sample point, or may include a plurality of sample points, when the target inverse phase noise is generated, a group of target inverse phase noise may be generated at each sample point, or a group of target inverse phase noise may be generated in one frame.

In embodiments of the present disclosure, when the plurality of groups of target noise cancellation parameters are determined, frequency division is not performed on the downlink signals, that is, the plurality of groups of target noise cancellation parameters are determined based on full-band downlink signals. In this way, after the plurality of groups of target inverse phase noise that are in the one-to-one correspondence with the plurality of first speakers are generated based on the plurality of groups of target noise cancellation parameters, a frequency band of each target inverse phase noise in the plurality of groups of target inverse phase noise covers a sound-making frequency band of the plurality of first speakers, that is, the frequency band of each target inverse phase noise is a full frequency band.

Step 203: Perform noise cancellation through the plurality of first speakers by using the plurality of groups of target inverse phase noise.

After the plurality of groups of target inverse phase noise are generated, the plurality of groups of target inverse phase noise are respectively mixed with k^{th}-frame downlink signals to be played through the plurality of first speakers, and then mixed signals are played through the corresponding first speakers, to achieve noise cancellation.

Some of the plurality of first speakers may be high-band speakers, and the other may be low-band speakers. Alternatively, some of the plurality of first speakers are full-band speakers, and the other are non-full-band speakers. In other words, the sound-making frequency bands of the plurality of first speakers may be different. Alternatively, the plurality of first speakers are all full-band speakers. Alternatively, the plurality of first speakers are all non-full-band speakers. When the plurality of first speakers are all the full-band speakers, the k^{th}-frame downlink signals to be played through the plurality of first speakers are all the k^{th}-frame downlink signal sent by the user terminal. When not all of the plurality of first speakers are full-band speakers, frequency division needs to be performed, based on a sound-making frequency band of each first speaker, on the k^{th}-frame downlink signal sent by the user terminal, to obtain a k^{th}-frame downlink signal to be played through each first speaker.

Two first speakers in the plurality of first speakers may include two first speakers formed by one dual diaphragm (or referred to as dual-dynamic) loudspeaker. Alternatively, the plurality of first speakers include a plurality of split speakers/loudspeakers.

Optionally, the headset may further include at least one second speaker, and the at least one second speaker does not participate in noise cancellation. In this case, the second speaker may participate in downlink compensation (that is, downlink compensation is performed on a downlink signal sent by the user terminal, where the downlink signal is a full-band audio signal, including an audio signal of a sound-making frequency band of the second speaker). In this case, the first speaker may be a low- and medium-band speaker, or may be a full-band speaker, and the second speaker may be a high-band speaker, or may be a medium-band speaker or a low-band speaker. Optionally, the second speaker may not participate in downlink compensation. In this case, the first speaker may be the low- and medium-band speaker, or may be the full-band speaker, and the second speaker is the high-band speaker.

It should be noted that the sound-making frequency band of the at least one second speaker is higher than a sound-making frequency band of the at least one first speaker. Certainly, the sound-making frequency band of the at least one second speaker may alternatively be lower than the sound-making frequency band of the at least one first speaker. This is not limited in embodiments of the present disclosure.

In addition, the foregoing process of determining the plurality of groups of target noise cancellation parameters according to the adaptation method requires specific time, and when one frame includes a plurality of sample points and duration of the one frame is long, duration of determining the plurality of groups of target noise cancellation parameters is less than the duration of the one frame. Therefore, calculation may be performed in a part of a time period of the k^{th} frame based on related data of the (k−1)^{th} frame, to obtain a plurality of groups of target noise cancellation parameters in the k^{th} frame, and perform active noise cancellation in the other part of the time period of the k^{th} frame based on the plurality of groups of target noise cancellation parameters in the k^{th} frame. However, when the one frame includes one sample point, or the one frame includes a plurality of sample points and the duration of the one frame is short, the duration of determining the plurality of groups of target noise cancellation parameters may be equal to the duration of the one frame. In this case, calculation may need to be performed in the entire time period of the k^{th} frame based on the related data of the (k−1)^{th} frame, to obtain the plurality of groups of target noise cancellation parameters. In this case, the plurality of groups of target noise cancellation parameters may be determined as a plurality of groups of target noise cancellation parameters in the (k+1)^{th} frame, and then active noise cancellation is performed in a time period of the (k+1)^{th} frame based on the plurality of groups of target noise cancellation parameters in the (k+1)^{th} frame. The foregoing content is described by using the former case as an example.

In conclusion, in embodiments of the present disclosure, because the plurality of groups of target inverse phase noise are in the one-to-one correspondence with the plurality of first speakers, and the frequency band of each target inverse phase noise in the plurality of groups of target inverse phase noise covers the sound-making frequency band of the plurality of first speakers. In other words, each target inverse phase noise is full-band inverse phase noise. Therefore, regardless of whether the first speaker is a high-band speaker, a low-band speaker, or a full-band speaker, a noise cancellation capability of each first speaker can be fully utilized when the plurality of groups of target inverse phase noise are used to perform noise cancellation. In other words, in a headset architecture including a plurality of noise cancellation channels and a plurality of speakers, in this solution, noise cancellation effect of a headset can be improved by using full-band inverse phase noise of the plurality of noise cancellation channels.

The following describes several possible headset architectures in embodiments of the present disclosure as examples.

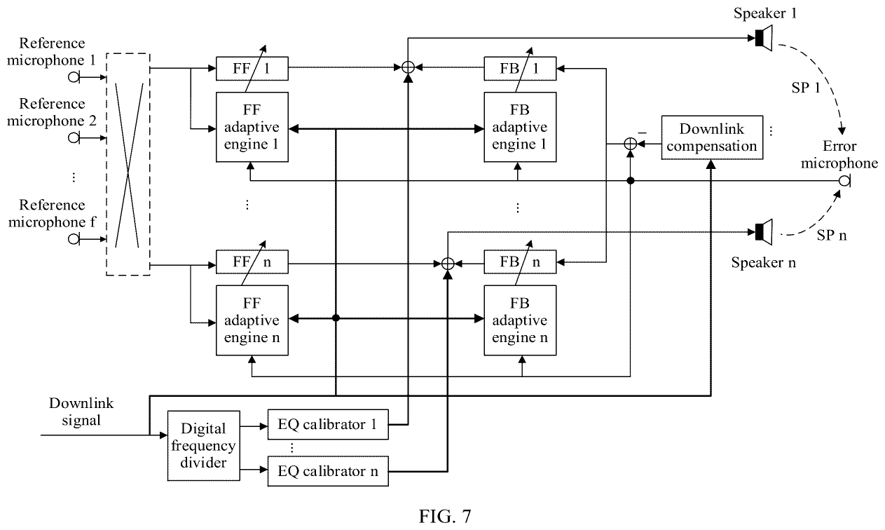

FIG. 7 is a diagram of a structure of a headset according to an embodiment of the present disclosure. Refer to FIG. 7. The headset includes f reference microphones, one error microphone, n FF filters, n FF adaptive engines that are in a one-to-one correspondence with the n FF filters, n FB filters, n FB adaptive engines that are in a one-to-one correspondence with the n FB filters, n first speakers (namely, a speaker 1 to a speaker n), a downlink compensation filter, a downlink compensation adaptive engine (not shown in the figure), a digital frequency divider, and n equalizers (EQ) calibrators. Both f and n are integers greater than or equal to 1, and f and n may be equal or may not be equal.

The f reference microphones are configured to collect a noise signal of an external environment, namely, a reference signal. The error microphone is configured to collect a noise signal, namely, an error signal, in an ear canal. The n FF adaptive engines are configured to: determine a k^{th}-frame filter coefficient of an FF filter corresponding to each of the n FF adaptive engines, and refresh the determined k^{th}-frame filter coefficient into the corresponding FF filter. The n FB adaptive engines are configured to: determine a k^{th}-frame filter coefficient of an FB filter corresponding to each of the n FB adaptive engines, and refresh the determined k^{th}-frame filter coefficient into the corresponding FB filter. The downlink compensation adaptive engine is configured to: determine a k^{th}-frame filter coefficient of the downlink compensation filter, and refresh the determined k^{th}-frame filter coefficient into the downlink compensation filter.

The digital frequency divider is configured to perform, based on a sound-making frequency band of the n first speakers, frequency division on a k^{th}-frame downlink signal sent by a user terminal, to obtain a k^{th}-frame downlink signal corresponding to each first speaker. The n EQ calibrators are configured to calibrate mass production parameters of the corresponding first speakers, so that tolerances of the mass production parameters of the n first speakers are aligned consistently.

When noise cancellation is performed, the n FF filters are configured to process, based on respective k^{th}-frame filter coefficients, k^{th}-frame reference signals collected by reference microphones corresponding to the n FF filters, to obtain feedforward inverse phase noise. The downlink compensation filter is configured to perform, based on the k^{th}-frame filter coefficient of the downlink compensation filter, downlink compensation on the k^{th}-frame downlink signal sent by the user terminal. Then, after negation is performed on a k^{th}-frame downlink signal obtained through downlink compensation, audio mixing is performed on a negated k^{th}-frame downlink signal and a k^{th}-frame error signal collected by the error microphone, to obtain a k^{th}-frame noise signal collected by the error microphone. The n FB filters are configured to process, based on respective k^{th}-frame filter coefficients of the n FB filters, the k^{th}-frame noise signal collected by the error microphone, to obtain feedback inverse phase noise. Then, after feedforward inverse phase noise, feedback inverse phase noise, and a k^{th}-frame downlink signal of a first speaker of each noise cancellation channel are mixed, a mixed signal is played through the corresponding first speaker, to implement noise cancellation.

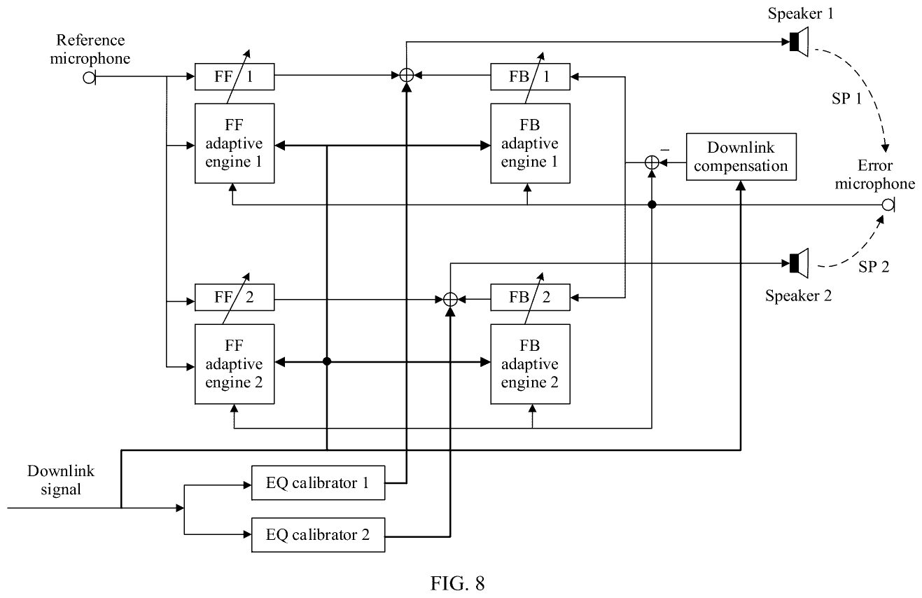

FIG. 8 is a diagram of a structure of another headset according to an embodiment of the present disclosure. Refer to FIG. 8. The headset includes one reference microphone, one error microphone, two FF filters, two FF adaptive engines that are in a one-to-one correspondence with the two FF filters, two FB filters, two FB adaptive engines that are in a one-to-one correspondence with the two FB filters, two first speakers (namely, a speaker 1 and a speaker 2), a downlink compensation filter, a downlink compensation adaptive engine (not shown in the figure), and two EQ calibrators. Both the two FF filters correspond to the reference microphone, and the two first speakers are speakers formed by a dual diaphragm (or referred to as dual-dynamic) loudspeaker. In this case, the headset may not include a digital frequency divider. In addition, the two first speakers may be considered as a combination of two dynamic loudspeakers but share a magnetic circuit, and are physically considered as one speaker. Because both the two dynamic loudspeakers have a good full-band sound-making capability, it may be considered that two full-band ANC noise cancellation modules are superposed. In this way, a noise cancellation capability of the speaker can be fully utilized.

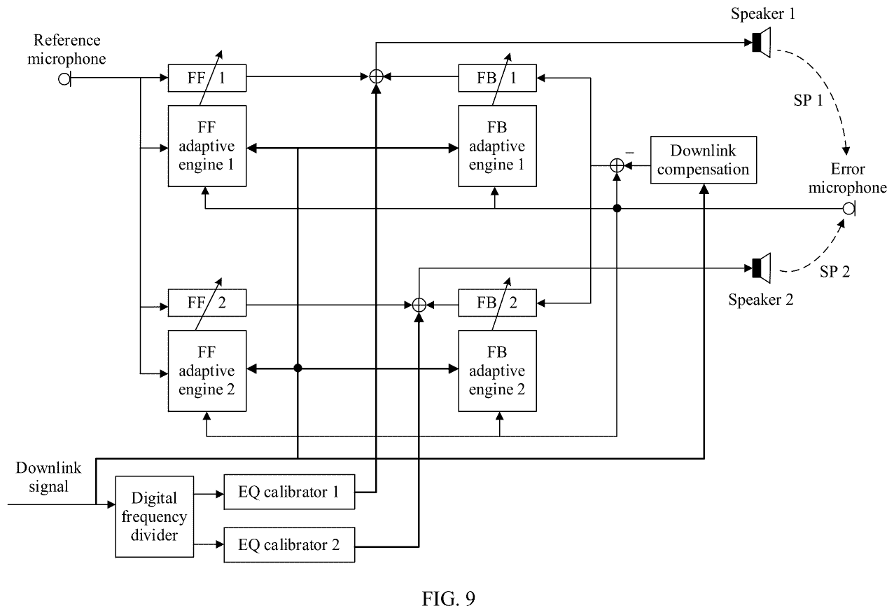

FIG. 9 is a diagram of a structure of another headset according to an embodiment of the present disclosure. Refer to FIG. 9. The headset includes one reference microphone, one error microphone, two FF filters, two FF adaptive engines that are in a one-to-one correspondence with the two FF filters, two FB filters, two FB adaptive engines that are in a one-to-one correspondence with the two FB filters, two first speakers (namely, a speaker 1 and a speaker 2), a downlink compensation filter, a downlink compensation adaptive engine (not shown in the figure), a digital frequency divider, and two EQ calibrators. A difference from FIG. 8 lies in that there are two physical entities of the first speakers, and the two split first speakers may be different or may be the same. Although the two first speakers are not completely the same, from an independent perspective, each first speaker can be designed as a full-band noise cancellation unit. In this way, a maximum noise cancellation capability of each speaker is fully utilized.

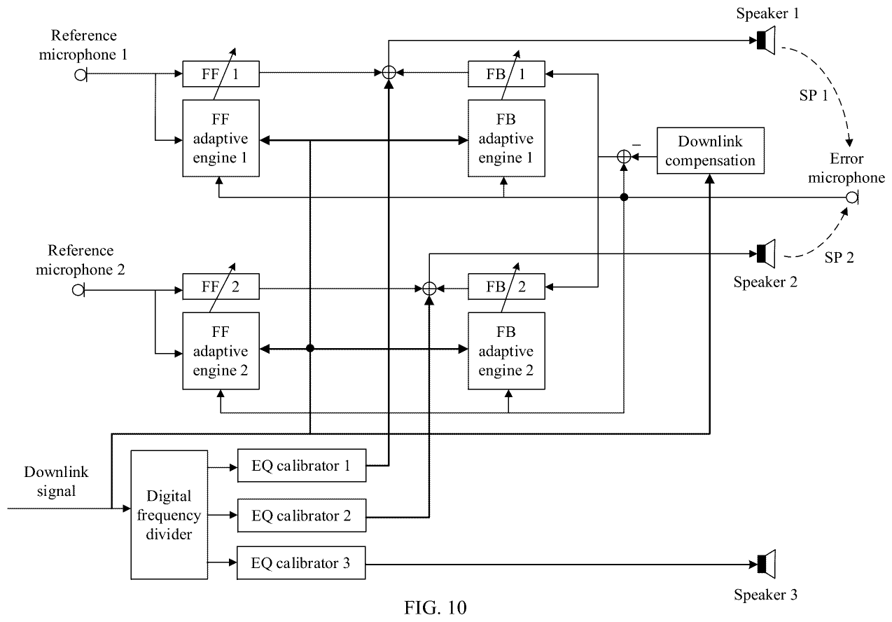

FIG. 10 is a diagram of a structure of another headset according to an embodiment of the present disclosure. Refer to FIG. 10. The headset includes two reference microphones, one error microphone, two FF filters, two FF adaptive engines that are in a one-to-one correspondence with the two FF filters, two FB filters, two FB adaptive engines that are in a one-to-one correspondence with the two FB filters, two first speakers (namely, a speaker 1 and a speaker 2), one second speaker (namely, a speaker 3), a downlink compensation filter, a downlink compensation adaptive engine (not shown in the figure), a digital frequency divider, and three EQ calibrators. In FIG. 10, three speakers are used to meet a high-definition sound quality requirement. Frequency responses of the three speakers separately focus on low, medium, and high frequency bands. Two of the three speakers (namely, the speaker 1 and the speaker 2) serving as the first speakers participate in noise cancellation, and the other speaker (namely, the speaker 3) serving as the second speaker does not participate in noise cancellation, but the second speaker participates in downlink compensation (that is, downlink compensation is performed on a downlink signal sent by a user terminal, where the downlink signal is a full-band audio signal, including an audio signal at a sound-making frequency band of the second speaker). The first speaker may be a low- and medium-band speaker, or may be a full-band speaker, and the second speaker may be a high-band speaker, or may be a medium-band speaker or a low-band speaker.

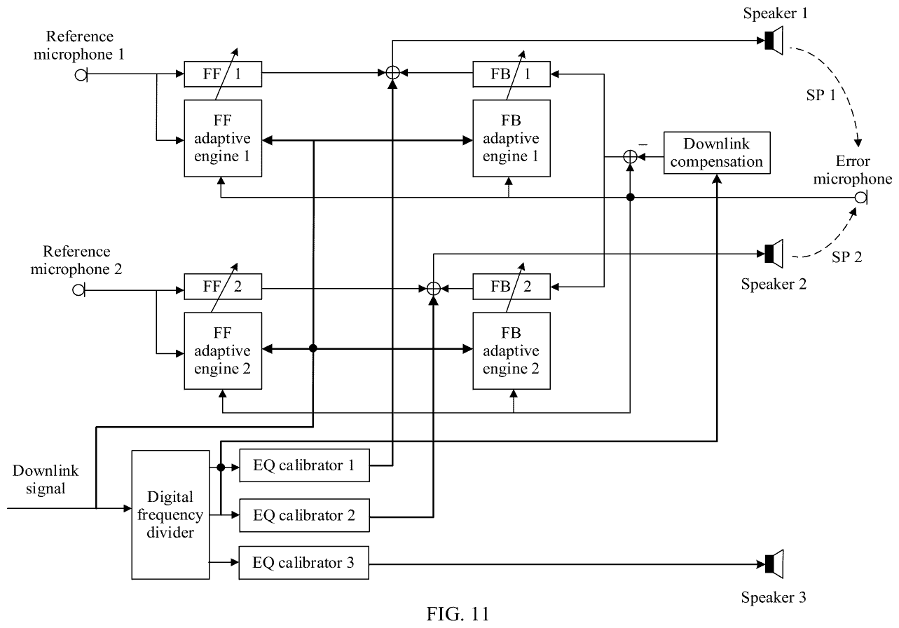

Optionally, a current mainstream ANC chip may not obtain a signal of a high-band speaker. Therefore, refer to FIG. 11. The second speaker may not participate in downlink compensation (that is, after digital frequency division is performed on the downlink signal sent by the user terminal, downlink signals corresponding to the two first speakers are obtained, and downlink compensation is performed on the downlink signals corresponding to the two first speakers, and is not performed on a downlink signal corresponding to the second speaker). In this case, the first speakers may be low- and medium-band speakers, or may be full-band speakers, and the second speaker is a high-band speaker. To reduce damage of ANC to downlink sound quality, a frequency division point of the high-band speaker may be above 6 kHz, that is, an audio signal above 6 kHz is not compensated. Certainly, a frequency division point at 6 kHz is not limited in embodiments of the present disclosure, and there may be another high frequency division point.

It should be noted that the FF adaptive engines, the FB adaptive engines, and the downlink compensation adaptive engine mentioned above may be deployed on a micro control unit. The FF filters, the FB filters, and the downlink compensation filter may be deployed on an ANC chip. The micro control unit and the ANC chip may be collectively referred to as a noise cancellation processor. The micro control unit and the ANC chip may be integrated on one chip, or may be deployed on two chips.

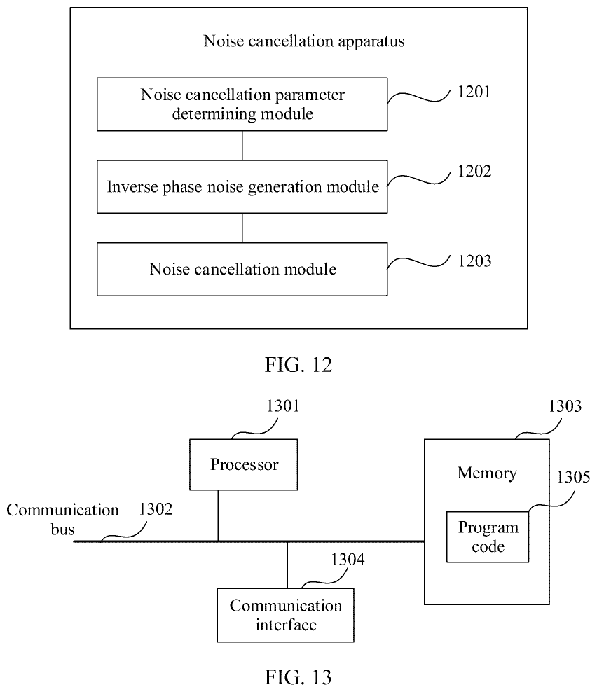

FIG. 12 is a diagram of a structure of a noise cancellation apparatus according to an embodiment of the present disclosure. The noise cancellation apparatus may be implemented as a part or all of a headset by software, hardware, or a combination thereof. The headset may be the headset shown in FIG. 1. Refer to FIG. 12. The apparatus includes: a noise cancellation parameter determining module 1201, an inverse phase noise generation module 1202, and a noise cancellation module 1203.

The noise cancellation parameter determining module 1201 is configured to determine a plurality of groups of target noise cancellation parameters that are in a one-to-one correspondence with a plurality of first speakers.

The inverse phase noise generation module 1202 is configured to generate, based on the plurality of groups of target noise cancellation parameters, a plurality of groups of target inverse phase noise that are in a one-to-one correspondence with the plurality of first speakers, where a frequency band of each target inverse phase noise in the plurality of groups of target inverse phase noise covers a sound-making frequency band of the plurality of first speakers.

The noise cancellation module 1203 is configured to perform noise cancellation through the plurality of first speakers by using the plurality of groups of target inverse phase noise.

Optionally, the headset further includes a plurality of FF filters that are in a one-to-one correspondence with the plurality of first speakers, and the plurality of groups of target noise cancellation parameters include k^{th}-frame filter coefficients of the plurality of FF filters, where k is an integer greater than or equal to 1.

The noise cancellation parameter determining module 1201 includes: a first FF filter coefficient determining submodule configured to: when k is equal to 1, determine initial filter coefficients of the plurality of FF filters as the k^{th}-frame filter coefficients of the plurality of FF filters, or determine the k^{th}-frame filter coefficients of the plurality of FF filters based on an initial noise canceling level and a mapping relationship between a noise canceling level and an FF filter coefficient; or a second FF filter coefficient determining submodule configured to: when k is greater than 1, determine the k^{th}-frame filter coefficients of the plurality of FF filters based on a (k−1)^{th}-frame reference signal collected by at least one reference microphone, a (k−1)^{th}-frame error signal collected by an error microphone, and a target noise canceling level.

Optionally, the second FF filter coefficient determining submodule is specifically configured to: determine (k−1)^{th}-frame filter coefficients of a plurality of secondary paths SPs based on the target noise canceling level and a mapping relationship between a noise canceling level and a filter coefficient of an SP, where the plurality of SPs are paths from the plurality of first speakers to the error microphone; and determine the k^{th}-frame filter coefficients of the plurality of FF filters based on the (k−1)^{th}-frame reference signal collected by the at least one reference microphone, the (k−1)^{th}-frame error signal collected by the error microphone, and the (k−1)^{th}-frame filter coefficients of the plurality of SPs.

Optionally, the second FF filter coefficient determining submodule is further specifically configured to: determine a k^{th}-frame filter coefficient of a target FF filter by using one of the plurality of FF filters as the target FF filter based on the following operations until a k^{th}-frame filter coefficient of each FF filter is determined: if the target FF filter is a first FF filter, determining the k^{th}-frame filter coefficient of the target FF filter based on a (k−1)^{th}-frame reference signal collected by a target reference microphone, the (k−1)^{th}-frame error signal collected by the error microphone, and a (k−1)^{th}-frame filter coefficient of a target SP, where the target reference microphone is a reference microphone corresponding to the target FF filter, and the target SP is a path from a first speaker corresponding to the target FF filter to the error microphone; or if the target FF filter is a non-first FF filter, determining the k^{th}-frame filter coefficient of the target FF filter based on a (k−1)^{th}-frame reference signal collected by a target reference microphone, the (k−1)^{th}-frame error signal collected by the error microphone, the (k−1)^{th}-frame filter coefficients of the plurality of SPs, and k^{th}-frame frequency response information and (k−1)^{th}-frame frequency response information that are of each FF filter before the target FF filter.

Optionally, the headset further includes a plurality of FB filters that are in a one-to-one correspondence with the plurality of first speakers.

The second FF filter coefficient determining submodule is further specifically configured to: determine the kth-frame filter coefficients of the plurality of FF filters based on the (k−1)th-frame reference signal collected by the at least one reference microphone, the (k−1)th-frame error signal collected by the error microphone, the (k−1)th-frame filter coefficients of the plurality of SPs, and (k−1)th-frame filter coefficients of the plurality of FB filters.

Optionally, the second FF filter coefficient determining submodule is further specifically configured to: determine a kth-frame filter coefficient of a target FF filter by using one of the plurality of FF filters as the target FF filter based on the following operations until a kth-frame filter coefficient of each FF filter is determined: if the target FF filter is a first FF filter, determining the kth-frame filter coefficient of the target FF filter based on a (k−1)th-frame reference signal collected by a target reference microphone, the (k−1)^{th}-frame error signal collected by the error microphone, the (k−1)^{th}-frame filter coefficients of the plurality of SPs, and the (k−1)^{th}-frame filter coefficients of the plurality of FB filters, where the target reference microphone is a reference microphone corresponding to the target FF filter; or if the target FF filter is a non-first FF filter, determining the k^{th}-frame filter coefficient of the target FF filter based on a (k−1)^{th}-frame reference signal collected by a target reference microphone, the (k−1)^{th}-frame error signal collected by the error microphone, the (k−1)^{th}-frame filter coefficients of the plurality of SPs, the (k−1)^{th}-frame filter coefficients of the plurality of FB filters, and k^{th}-frame frequency response information and (k−1)^{th}-frame frequency response information that are of each FF filter before the target FF filter.

Optionally, the headset further includes the plurality of feedback FB filters that are in the one-to-one correspondence with the plurality of first speakers, and the plurality of groups of target noise cancellation parameters further include kth-frame filter coefficients of the plurality of FB filters, where k is an integer greater than or equal to 1.

The noise cancellation parameter determining module further includes: a first FB filter coefficient determining submodule configured to: when k is equal to 1, determine initial filter coefficients of the plurality of FB filters as the kth-frame filter coefficients of the plurality of FB filters, or determine the kth-frame filter coefficients of the plurality of FB filters based on the initial noise canceling level and a mapping relationship between a noise canceling level and an FB filter coefficient; or a second FB filter coefficient determining submodule configured to: when k is greater than 1, determine the kth-frame filter coefficients of the plurality of FB filters based on the target noise canceling level.

Optionally, the second FB filter coefficient determining submodule is specifically configured to: determine a kth-frame filter coefficient of a target FB filter by using one of the plurality of FB filters as the target FB filter based on the following operations until a kth-frame filter coefficient of each FB filter is determined: determining the kth-frame filter coefficient of the target FB filter based on the target noise canceling level and the mapping relationship between the noise canceling level and the FB filter coefficient; or if the target FB filter is a first-type FB filter, determining the k^{th}-frame filter coefficient of the target FB filter based on the target noise canceling level and the mapping relationship between the noise canceling level and the FB filter coefficient; or if the target FB filter is a second-type FB filter, determining the k^{th}-frame filter coefficient of the target FB filter based on the (k−1)^{th}-frame error signal collected by the error microphone, a (k−1)^{th}-frame filter coefficient of the target FB filter, and the target noise canceling level.

Optionally, the second FB filter coefficient determining submodule is further specifically configured to: determine a (k−1)th-frame filter coefficient of a target secondary path SP based on the target noise canceling level and the mapping relationship between the noise canceling level and the filter coefficient of the SP, where the target SP is a path from a first speaker corresponding to the target FB filter to the error microphone; and determine the kth-frame filter coefficient of the target FB filter based on the (k−1)th-frame error signal collected by the error microphone, the (k−1)th-frame filter coefficient of the target FB filter, and the (k−1)th-frame filter coefficient of the target SP.

Optionally, a sound-making frequency band of a first speaker corresponding to the first-type FB filter is higher than a sound-making frequency band of a first speaker corresponding to the second-type FB filter.

Optionally, the apparatus further includes: a first noise canceling level determining module configured to determine a (k−1)th-frame noise canceling level; a noise canceling level obtaining module configured to obtain noise canceling levels in m frames before a (k−1)th frame, where m is greater than or equal to 1 and less than k−1; and a second noise canceling level determining module configured to determine the target noise canceling level based on the (k−1)th-frame noise canceling level and the noise canceling levels in the m frames.

Optionally, the first noise canceling level determining module is specifically configured to: when no valid downlink signal exists and an environment is not quiet in the (k−1)th frame, determine the (k−1)th-frame noise canceling level based on reference filter coefficients of the plurality of FF filters and a mapping relationship between a noise canceling level and frequency response information of an FF filter, where when k is equal to 2, the reference filter coefficients are initial filter coefficients of the corresponding FF filters; or when k is greater than 2, the reference filter coefficients are filter coefficients that are of the corresponding FF filters and that meet a convergence stability condition last time before a kth frame, or are (k−1)th-frame filter coefficients of the corresponding FF filters.

Optionally, the first noise canceling level determining module is specifically configured to: determine reference frequency response information of the plurality of FF filters based on the reference filter coefficients of the plurality of FF filters; determine, based on the mapping relationship between the noise canceling level and the frequency response information of the FF filter, noise canceling levels matching the reference frequency response information of the plurality of FF filters, to obtain a plurality of reference noise canceling levels; and determine the (k−1)th-frame noise canceling level based on the plurality of reference noise canceling levels.

Optionally, the first noise canceling level determining module is further specifically configured to: determine the (k−1)th-frame noise canceling level based on an average value of the plurality of reference noise canceling levels; or determine the (k−1)th-frame noise canceling level based on a reference noise canceling level with a largest quantity in the plurality of reference noise canceling levels.

Optionally, the first noise canceling level determining module is specifically configured to: when a valid downlink signal exists in the (k−1)th frame, determine the (k−1)th-frame noise canceling level based on the (k−1)th-frame valid downlink signal, the (k−1)th-frame reference signal collected by the at least one reference microphone, and the (k−1)th-frame error signal collected by the error microphone.

Optionally, a filter coefficient of each FF filter includes at least one biquad filter coefficient and one gain.

In conclusion, in embodiments of the present disclosure, the plurality of groups of target inverse phase noise are in a one-to-one correspondence with the plurality of first speakers, and a frequency band of each target inverse phase noise in the plurality of groups of target inverse phase noise covers a sound-making frequency band of the plurality of first speakers. In other words, the target inverse phase noise is full-band inverse phase noise. Therefore, regardless of whether the first speaker is a high-band speaker, a low-band speaker, or a full-band speaker, a noise cancellation capability of each first speaker can be fully utilized when the target inverse phase noise is used to perform noise cancellation. In other words, in a headset architecture including a plurality of noise cancellation channels and a plurality of speakers, in this solution, noise cancellation effect of a headset can be improved by using full-band inverse phase noise of the plurality of noise cancellation channels.

It should be noted that, during noise cancellation performed by the noise cancellation apparatus provided in embodiments, division of the function modules is only used as an example for description. In actual application, the functions may be allocated to different function modules for implementation, depending on a requirement. In other words, an internal structure of an apparatus is divided into different function modules to implement all or some of the functions described above. In addition, the noise cancellation apparatus provided in embodiments and embodiments of the noise cancellation method pertain to a same concept. For a specific implementation process of the noise cancellation apparatus, refer to the method embodiments.

Refer to FIG. 13. FIG. 13 is a diagram of a structure of another headset according to an embodiment of the present disclosure. The headset includes one or more processors 1301, a communication bus 1302, a memory 1303, and one or more communication interfaces 1304.

The processor 1301 is a general-purpose central processing unit (CPU), a network processor (NP), a microprocessor, or one or more integrated circuits configured to implement the solutions of the present disclosure, for example, an application-specific integrated circuit (ASIC), a programmable logic device (PLD), or a combination thereof. Optionally, the PLD is a complex programmable logic device (CPLD), a field-programmable gate array (FPGA), generic array logic (GAL), or any combination thereof.

The communication bus 1302 is configured to transmit information between the foregoing components. Optionally, the communication bus 1302 may be classified as an address bus, a data bus, a control bus, and the like. For ease of representation, only one thick line is used to represent the bus in the figure, but this does not mean that there is only one bus or only one type of bus.

Optionally, the memory 1303 is a read-only memory (ROM), a random access memory (RAM), an electrically erasable programmable read-only memory (EEPROM), an optical disc (including a compact disc read-only memory (CD-ROM), a compact disc, a laser disc, a digital versatile disc, a Blu-ray disc, and the like), a magnetic disk storage medium, another magnetic storage device, or any other medium that can be used to carry or store expected program code in a form of an instruction or a data structure and that can be accessed by a computer, but is not limited thereto. The memory 1303 exists independently, and is connected to the processor 1301 through the communication bus 1302, or the memory 1303 is integrated with the processor 1301.

The communication interface 1304 is configured to communicate with another device or a communication network by using any transceiver-type apparatus. The communication interface 1304 includes a wired communication interface, or may optionally include a wireless communication interface. The wired communication interface is, for example, an Ethernet interface. Optionally, the Ethernet interface is an optical interface, an electrical interface, or a combination thereof. The wireless communication interface is a wireless local area network (WLAN) interface, a cellular network communication interface, a combination thereof, or the like.

In some embodiments, the memory 1303 is configured to store program code 1305 for executing the solutions of the present disclosure. The processor 1301 can execute the program code 1305 stored in the memory 1303. The program code includes one or more software modules, and the headset can implement, through the processor 1301 and the program code 1305 in the memory 1303, the noise cancellation method provided in embodiments in FIG. 2.

All or some of the foregoing embodiments may be implemented by using software, hardware, firmware, or any combination thereof. When software is used to implement the foregoing embodiments, all or some of embodiments may be implemented in a form of a computer program product. The computer program product includes one or more computer instructions. When the computer instructions are loaded and executed on a computer, the procedure or functions according to embodiments of the present disclosure are all or partially generated. The computer may be a general-purpose computer, a dedicated computer, a computer network, or other programmable apparatuses. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by the computer, or a data storage device like a server or a data center, integrating one or more usable media. The usable medium may be a magnetic medium (for example, a floppy disk, a hard disk, or a magnetic tape), an optical medium (for example, a digital versatile disc (DVD)), a semiconductor medium (for example, a solid-state disk (SSD)), or the like. It should be noted that the computer-readable storage medium mentioned in embodiments of the present disclosure may be a non-volatile storage medium, that is, may be a non-transitory storage medium.

An embodiment of the present disclosure further provides a computer-readable storage medium. The storage medium stores a computer program, and when the computer program is executed by a processor, the steps of the foregoing method are implemented.

An embodiment of the present disclosure further provides a computer program product. The computer program product stores computer instructions, and when the computer instructions are executed by a processor, the steps of the foregoing method are implemented.

It should be understood that “at least one” mentioned in this specification indicates one or more, and “a plurality of” indicates two or more. In the descriptions of embodiments of the present disclosure, “/” indicates “or” unless otherwise specified. For example, A/B may indicate A or B. In this specification, “and/or” describes only an association relationship between associated objects and indicates that three relationships may exist. For example, A and/or B may indicate the following three cases: Only A exists, both A and B exist, and only B exists. In addition, to clearly describe the technical solutions in embodiments of the present disclosure, terms such as “first” and “second” are used in embodiments of the present disclosure to distinguish between same items or similar items that provide basically same functions or purposes. A person skilled in the art may understand that the terms such as “first” and “second” do not limit a quantity or an execution sequence, and the terms such as “first” and “second” do not indicate a definite difference.

It should be noted that information (including but not limited to user equipment information, personal information of a user, and the like), data (including but not limited to data used for analysis, stored data, displayed data, and the like), and signals in embodiments of the present disclosure are used under authorization by the user or full authorization by all parties, and capturing, use, and processing of related data need to conform to related laws, regulations, and standards of related countries and regions.

The foregoing descriptions are merely embodiments of the present disclosure, but are not intended to limit the present disclosure. Any modification, equivalent replacement, or improvement made without departing from the spirit and principle of the present disclosure should fall within the protection scope of this application.

What is claimed is:

1. A noise method comprising:
determining a plurality of groups of target noise cancellation parameters that are in a one-to-one correspondence with a plurality of first speakers of a headset;
generating, based on the plurality of groups of target noise cancellation parameters, a plurality of groups of target inverse phase noise that are in a one-to-one correspondence with the plurality of first speakers, wherein a frequency band of each target inverse phase noise in the plurality of groups of target inverse phase noise covers a sound-making frequency band of the plurality of first speakers; and
performing noise cancellation through the plurality of first speakers by using the plurality of groups of target inverse phase noise.

2. The method of claim 1, wherein the plurality of groups of target noise cancellation parameters comprise k^{th}-frame filter coefficients of a plurality of feedforward (FF) filters of the headset, wherein the plurality of FF filters are in a one-to-one correspondence with the plurality of first speakers, wherein k is an integer greater than or equal to 1, and wherein determining the plurality of groups of target noise cancellation parameters comprises:
determining, when k is equal to 1, initial filter coefficients of the plurality of FF filters as the k^{th}-frame filter coefficients of the plurality of FF filters; or
determining, when k is equal to 1, the k^{th}-frame filter coefficients of the plurality of FF filters based on an initial noise canceling level and a first mapping relationship between a noise canceling level and an FF filter coefficient; or
determining, when k is greater than 1, the k^{th}-frame filter coefficients of the plurality of FF filters based on a first (k−1)^{th}-frame reference signal from at least one reference microphone of the headset, a (k−1)^{th}-frame error signal from an error microphone of the headset, and a target noise canceling level.

3. The method of claim 2, wherein determining the k^{th}-frame filter coefficients of the plurality of FF filters based on the first (k−1)^{th}-frame reference signal, the (k−1)^{th}-frame error signal, and the target noise canceling level comprises:
determining (k−1)^{th}-frame filter coefficients of a plurality of secondary paths (SPs) based on the target noise canceling level and a second mapping relationship between the noise canceling level and a filter coefficient of an SP, wherein the plurality of SPs are paths from the plurality of first speakers to the error microphone; and
determining the k^{th}-frame filter coefficients of the plurality of FF filters based on the first (k−1)^{th}-frame reference signal, the (k−1)^{th}-frame error signal, and the (k−1)^{th}-frame filter coefficients of the plurality of SPs.

4. The method of claim 3, wherein determining the k^{th}-frame filter coefficients of the plurality of FF filters based on the first (k−1)^{th}-frame reference signal, the (k−1)^{th}-frame error signal, and the (k−1)^{th}-frame filter coefficients of the plurality of SPs comprises determining a k^{th}-frame filter coefficient of a target FF filter by using one of the plurality of FF filters as the target FF filter based on the following operations until a k^{th}-frame filter coefficient of each FF filter is determined:
determining, when the target FF filter is a first FF filter, the k^{th}-frame filter coefficient of the target FF filter based on a second (k−1)^{th}-frame reference signal from a target reference microphone, the (k−1)^{th}-frame error signal, and a (k−1)^{th}-frame filter coefficient of a target SP, wherein the target reference microphone is a corresponds to the target FF filter, and wherein the target SP is a path from a first speaker corresponding to the target FF filter to the error microphone; or
determining, when the target FF filter is a non-first FF filter, the k^{th}-frame filter coefficient of the target FF filter based on the second (k−1)^{th}-frame reference signal, the (k−1)^{th}-frame error signal, the (k−1)^{th}-frame filter coefficients of the plurality of SPs, and k^{th}-frame frequency response information and (k−1)^{th}-frame frequency response information of each FF filter before the target FF filter.

5. The method of claim 3, wherein determining the k^{th}-frame filter coefficients of the plurality of FF filters based on the first (k−1)^{th}-frame reference signal, the (k−1)^{th}-frame error signal, and the (k−1)^{th}-frame filter coefficients of the plurality of SPs comprises determining the k^{th}-frame filter coefficients of the plurality of FF filters based on the first (k−1)^{th}-frame reference signal, the (k−1)^{th}-frame error signal, the (k−1)^{th}-frame filter coefficients of the plurality of SPs, and (k−1)^{th}-frame filter coefficients of a plurality of feedback (FB) filters of the headset, and wherein the plurality of FB filters are in a one-to-one correspondence with the plurality of first speakers.

6. The method of claim 5, wherein determining the k^{th}-frame filter coefficients of the plurality of FF filters based on the first (k−1)^{th}-frame reference signal, the (k−1)^{th}-frame error signal, the (k−1)^{th}-frame filter coefficients of the plurality of SPs, and the (k−1)^{th}-frame filter coefficients of the plurality of FB filters comprises determining a k^{th}-frame filter coefficient of a target FF filter by using one of the plurality of FF filters as the target FF filter based on the following operations until a k^{th}-frame filter coefficient of each FF filter is determined:
determining, when the target FF filter is a first FF filter, the k^{th}-frame filter coefficient of the target FF filter based on a second (k−1)^{th}-frame reference signal from a target reference microphone, the (k−1)^{th}-frame error signal, the (k−1)^{th}-frame filter coefficients of the plurality of SPs, and the (k−1)^{th}-frame filter coefficients of the plurality of FB filters, wherein the target reference microphone corresponds to the target FF filter; or
determining, when the target FF filter is a non-first FF filter, the k^{th}-frame filter coefficient of the target FF filter based on the second (k−1)^{th}-frame reference signal, the (k−1)^{th}-frame error signal, the (k−1)^{th}-frame filter coefficients of the plurality of SPs, the (k−1)^{th}-frame filter coefficients of the plurality of FB filters, and k^{th}-frame frequency response information and (k−1)^{th}-frame frequency response information of each FF filter before the target FF filter.

7. The method of claim 1, wherein the plurality of groups of target noise cancellation parameters further comprise k^{th}-frame filter coefficients of a plurality of feedback (FB) filters of the headset, wherein the plurality of FB filters are in the one-to-one correspondence with the plurality of first speakers, wherein k is an integer greater than or equal to 1, and wherein determining the plurality of groups of target noise cancellation parameters comprises:
determining, when k is equal to 1, initial filter coefficients of the plurality of FB filters as the k^{th}-frame filter coefficients of the plurality of FB filters; or
determining, when k is equal to 1, the k^{th}-frame filter coefficients of the plurality of FB filters based on an initial noise canceling level and a first mapping relationship between a noise canceling level and an FB filter coefficient; or
determining, when k is greater than 1, the k^{th}-frame filter coefficients of the plurality of FB filters based on a target noise canceling level.

8. The method of claim 7, wherein the determining the k^{th}-frame filter coefficients of the plurality of FB filters based on the target noise canceling level comprises determining a k^{th}-frame filter coefficient of a target FB filter by using one of the plurality of FB filters as the target FB filter based on the following operations until a k^{th}-frame filter coefficient of each FB filter is determined:
determining, when the target FB filter is a first-type FB filter, the k^{th}-frame filter coefficient of the target FB filter based on the target noise canceling level and the first mapping relationship; or
determining, when the target FB filter is a second-type FB filter, the k^{th}-frame filter coefficient of the target FB filter based on the (k−1)^{th}-frame error signal, a (k−1)^{th}-frame filter coefficient of the target FB filter, and the target noise canceling level.

9. The method of claim 8, wherein determining the k^{th}-frame filter coefficient of the target FB filter based on the (k−1)^{th}-frame error signal, the (k−1)^{th}-frame filter coefficient of the target FB filter, and the target noise canceling level comprises:
determining a (k−1)^{th}-frame filter coefficient of a target secondary path (SP) based on the target noise canceling level and a second mapping relationship between the noise canceling level and a filter coefficient of the SP, wherein the target SP is a path from a first speaker corresponding to the target FB filter to an error microphone of the headset; and
determining the k^{th}-frame filter coefficient of the target FB filter based on the (k−1)^{th}-frame error signal, the (k−1)^{th}-frame filter coefficient of the target FB filter, and the (k−1)^{th}-frame filter coefficient of the target SP.

10. The method of claim 8, wherein a first sound-making frequency band of a first speaker corresponding to the first-type FB filter is higher than a second sound-making frequency band of the first speaker corresponding to the second-type FB filter.

11. The method of claim 2, further comprising:
determining a (k−1)^{th}-frame noise canceling level;
obtaining noise canceling levels in m frames before a (k−1)^{th} frame, wherein m is greater than or equal to 1 and less than k−1; and
determining the target noise canceling level based on the (k−1)^{th}-frame noise canceling level and the noise canceling levels in the m frames.

12. The method of claim 11, wherein determining the (k−1)^{th}-frame noise canceling level comprises determining, when no valid downlink signal exists and an environment is not quiet in the (k−1)^{th} frame, the (k−1)^{th}-frame noise canceling level based on reference filter coefficients of the plurality of FF filters and a second mapping relationship between the noise canceling level and frequency response information of an FF filter, wherein when k is equal to 2, the reference filter coefficients are initial filter coefficients of the corresponding FF filters, when k is greater than 2, the reference filter coefficients are filter coefficients that are of the corresponding FF filters and that meet a convergence stability condition last time before a k^{th} frame, or when k is greater than 2, the reference filter coefficients are (k−1)^{th}-frame filter coefficients of the corresponding FF filters.

13. The method of claim 12, wherein determining the (k−1)^{th}-frame noise canceling level based on reference filter coefficients of the plurality of FF filters and the second mapping relationship comprises:
determining reference frequency response information of the plurality of FF filters based on the reference filter coefficients of the plurality of FF filters;
determining, based on the second mapping relationship, noise canceling levels matching the reference frequency response information to obtain a plurality of reference noise canceling levels; and
determining the (k−1)^{th}-frame noise canceling level based on the plurality of reference noise canceling levels.

14. The method of claim 13, wherein determining the (k−1)^{th}-frame noise canceling level based on the plurality of reference noise canceling levels comprises:
determining the (k−1)^{th}-frame noise canceling level based on an average value of the plurality of reference noise canceling levels; or
determining the (k−1)^{th}-frame noise canceling level based on a reference noise canceling level with a largest quantity in the plurality of reference noise canceling levels.

15. The method of claim 11, wherein determining the (k−1)^{th}-frame noise canceling level comprises determining, when a valid downlink signal exists in the (k−1)^{th} frame, the (k−1)^{th}-frame noise canceling level based on the (k−1)^{th}-frame valid downlink signal, the first (k−1)^{th}-frame reference signal, and the (k−1)^{th}-frame error signal.

16. The method of claim 2, wherein a filter coefficient of each FF filter comprises at least one biquad filter coefficient and one gain.

17. A headset comprising:
a reference microphone;
an error microphones;
a plurality of first speakers; and
one or more noise cancellation processors configured to:
determine a plurality of groups of target noise cancellation parameters that are in a one-to-one correspondence with the plurality of first speakers;
generate, based on the plurality of groups of target noise cancellation parameters, a plurality of groups of target inverse phase noise that are in a one-to-one correspondence with the plurality of first speakers, wherein a frequency band of each target inverse phase noise in the plurality of groups of target inverse phase noise covers a sound-making frequency band of the plurality of first speakers; and
perform noise cancellation through the plurality of first speakers by using the plurality of groups of target inverse phase noise.

18. The headset of claim 17, wherein the plurality of first speakers comprise two first speakers formed by one dual diaphragm loudspeaker; or wherein the plurality of first speakers comprise a plurality of speakers with a separate loudspeaker.

19. The headset of claim 17, wherein the headset further comprises at least one second speaker, and wherein the at least one second speaker does not participate in noise cancellation.

20. A non-transitory computer-readable storage medium storing a computer program, wherein when the computer program is executed by one or more processors of an apparatus, the computer program causes the apparatus to:
determine a plurality of groups of target noise cancellation parameters that are in a one-to-one correspondence with a plurality of first speakers;
generate, based on the plurality of groups of target noise cancellation parameters, a plurality of groups of target inverse phase noise that are in a one-to-one correspondence with the plurality of first speakers, wherein a frequency band of each target inverse phase noise in the plurality of groups of target inverse phase noise covers a sound-making frequency band of the plurality of first speakers; and
perform noise cancellation through the plurality of first speakers by using the plurality of groups of target inverse phase noise.
